(19) United States
(12) Patent Application Publication
(10) Pub. No.: US 2014/0245798 A1
(43) Pub. Date: Sep. 4, 2014

(54) Add-Lock

(71) Applicant: Christopher V. Beckman, San Diego, CA (US)

(72) Inventor: Christopher V. Beckman, San Diego, CA (US)

(21) Appl. No.: 13/783,416

(22) Filed: Mar. 4, 2013

(51) Int. Cl. E05B 63/00

(52) U.S. Cl. CPC E05B 63/00
USPC 70/14

(57) ABSTRACT

New non-damaging, yet installed portable door lock techniques are provided. Embodiments include both external and internal locking controls, with and without the use of keys and safety releases.

In some aspects of the invention, a locking device may be non-damagingly mounted, in both a locked and unlocked condition, on the door jamb and/or mortise or other latch-accepting hole of a doorway and, with a variably-extendible door-gripping member, lock a door to the doorway and/or wall. Some aspects implement low weight and size, yet high-strength materials to enhance portability for traveling users. Some external control options are physical, as well as electronic, despite the challenges presented in this regard for temporary, portable locks.

Examples of safety releases for external unlocking of the locking devices are also provided, and include remote access options. Embodiments also include cushioning and other devices for reducing lateral play, doorway damage and optimizing holding force.

### FIELD OF THE INVENTION

The present invention relates to the field of portable locks.

### BACKGROUND

Locks to secure property have been in use for millennia, dating to at least 2,000 B.C.E. in ancient Egypt. Some of the earliest known locks were created to secure doors, including the pin lock.

Multiple door locks are often used on the same door. For example, many residential homes include both a sprung latch and a deadbolt locking mechanism, for added security. Some doorlock mechanisms require substantial alterations to a door and surrounding doorjamb to install them, but other locks may be “portable” and “piggyback” on features of existing locks. For example, several such locks include a flange that may be inserted into a bolt- or latch-accepting mortise within the door and/or strikeplate of a doorjamb, and hold the door fast, via the stem of the door handle or the door itself. See, e.g., U.S. Pat. No. 4,022,503, to Bey; see also U.S. Pat. No. 6,416,089, to Wiliams.

Such portable, piggybacking door locks may be more suitable for temporary use because they require somewhat less locking apparatus. However, existing portable door locks are relatively inconvenient to use. Effective portable door locks are still generally too heavy and large to justify traveling with them, which is a main purpose of them. In addition, existing portable door locks also have the major disadvantage that they are mainly suitable for use in a room presently occupied by the user. Portable door locks, although available in some form for decades, are uncommonly used.

Although most people are accustomed to their use, door locks in general require a significant amount of time and attention to install and use. Portable door locks in particular require expertise and vigilance from an ordinary user, who must perform the installation and locking routines each time he or she wishes to lock a door with the lock.

It should be understood that the disclosures in this application related to the background of the invention, in, but not limited to this section titled “Background,” do not necessarily set forth prior art or other known aspects exclusively, and may instead include art that was invented concurrently or after the present invention and conception, and details of the inventor's own discoveries and work and work results.

### SUMMARY OF THE INVENTION

New non-damaging, yet installed portable door locking and unlocking techniques are provided. Embodiments include lock controls that may be actuated from inside and outside the room. Some embodiments implement physical lock controls, such as keys, buttons and pull-cords. However, other embodiments utilize wired and physical remote control, radio frequency, networked or wired GUIs, which permit access permissioning (e.g. by an administrator from a web or other network portal).

In some aspects of the invention, a locking device may be non-damagingly, temporarily mounted, in both a locked and unlocked condition, on the door jamb and/or mortise or other latch-accepting hole of a doorway and, with a variably-extendible tab, foot, shackle or other member, lock a door to the doorway and/or wall. Some embodiments may be used simultaneously with locking devices inherent in the remainder of the door and doorway.

A variety of different lock device tabs, members, shackles, feet and other aspects are provided for both non-damaging, non-permanent mounting (in both locked and unlocked conditions) and locking a door. Embodiments also comprise a variety of actuation options for users. Some aspects implement low weight and size, yet high-strength materials (such as high strength polymer zip ties), to enhance portability for traveling users. Some external control options are physical, as well as electronic, despite the challenges presented in this regard for temporary, portable locks. For example, in some aspects, movable core members are protected within a strip thin enough to fit between the door and doorway in a closed position.

Examples of safety releases for external unlocking of the locking devices include, but are not limited to, pull cords accessible from gaps between the door and doorframe, as well as other remote access options. Embodiments also include cushioning and other devices for reducing lateral play, doorway damage and optimizing holding force.

Canons of Construction and Definitions

The following terms shall have the following meanings, significance and senses, in addition to their ordinary and specific meanings, significances and senses in general usage and within the technological field(s) in which they are used.

“Add-Lock System,” in addition to its ordinary meaning and special meaning in the arts to which it relates and that may be relevant to this application, means any locking device, method or system that may be added to a door to a room, or other variable opening to a space or container, or other surrounding walls or materials present in or about the room, space or container prior to use of the Add-Lock System (“room”), without removal or substantial alterations or modifications to existing hardware of the room, and/or without substantial alterations to the remainder of the room itself that would require substantial labor and/or materials to rectify.
“GUI,” in addition to its ordinary meaning and special meaning in the arts to which it relates and that may be relevant to this application, means any device, object, method or technique comprising controls assisting or enabling a user to carry out or affect the performance, actuation, parameters, or other aspects of the invention, or any part thereof. A GUI comprises, but is not limited to, virtual controls, or a set thereof, represented by computer hardware and software (for example, actuable visual representations of tools by a computer system on a computer screen).

Where any term is set forth in a sentence, clause or statement (“statement”), each possible meaning, significance and/or sense of any term used in this application should be read as if separately, conjunctively and/or alternatively set forth in additional statements, as necessary to exhaust the possible meanings of each such term and each such statement.

It should also be understood that, for convenience and readability, this application may set forth particular pronouns and other linguistic qualifiers of various specific gender and number, but, where this occurs, all other logically possible gender and number alternatives should also be read in as both conjunctive and alternative statements, as if equally, separately set forth therein.

### BRIEF DESCRIPTION OF THE DRAWINGS

FIG. 1 is a side view illustrating part of a portable Add-Lock system that may be temporarily installed onto a standard door and doorframe and remotely actuated, for example, by radio frequency signals.

FIG. 2 is a portion of a view 2, previously shown within FIG. 1, but enlarged for magnification purposes.

FIG. 3 is an illustration of the external appearance of the portable Add-Lock system of FIGS. 1 and 2, from the same perspective as FIGS. 1 and 2, along with some additional actuation aspects.

FIGS. 3a-3c are perspective views, each depicting exemplary alternative embodiments for a physical remote control aspect of the portable Add-Lock system of FIGS. 1-3—namely, a facilitating handle of a flexible pull-cord.

FIG. 4 is an illustration of additional aspects of the portable Add-Lock system of FIGS. 1-3 and door jamb in which it is temporarily installed, from the same perspective as FIGS. 1-3.

FIG. 5 is a side-view cross-section illustration of additional aspects of the portable Add-Lock system of FIGS. 1-4.

FIG. 6 is a front-view of a lever-style doorknob, door and door jamb—in an opposing configuration from that pictured before—which serves as a platform for discussing further aspects of the invention.

FIG. 7 is a front view illustrating aspects of another portable Add-Lock system that may be temporarily installed onto a standard door and doorframe—such as the door and doorframe set forth in FIG. 6.

FIG. 8 is a side-view illustration of additional aspects of the portable Add-Lock system of FIG. 7.

FIG. 9 is a front, partial cutaway view of the Add-Lock system discussed with respect to FIGS. 7 and 8, depicting additional aspects of the invention.

FIG. 10 depicts an alternative embodiment of an Add-Lock system, in which a lockable rotary foot may directly engage with a door to variably lock it.

FIG. 11 depicts another alternative embodiment of an Add-Lock system comprising a sliding and variably locking foot, which, as with the system depicted in FIG. 10, may directly engage with a door to lock it.

FIG. 12 depicts an Add-Lock system with a small profile and light weight, and many (though not all) important features of previous exemplary embodiments.

FIG. 13 depicts a manual remote control terminal and GUI system, which may be used in conjunction with a wide variety of Add-Lock systems discussed in this application.

FIG. 14 depicts another manual remote control terminal and GUI system (“control system”), which, as with the system discussed with reference to FIG. 13, may be used in conjunction with a wide variety of Add-Lock systems discussed in this application.

FIG. 15 illustrates an Add-Lock system which may be threaded over a lever-style doorknob to temporarily install it.

FIG. 16 illustrates another Add-Lock system which may be clamped over a more conventional doorknob, to temporarily install it.

FIG. 17 demonstrates the potential outward appearance (from the perspective of a person on the outside of a locked space) of a potential manual remote control terminal and GUI system, such as those discussed with reference to FIGS. 13 and 14.

FIGS. 18 and 19 provide a back perspective-and side view, respectively, of another alternative embodiment of an Add-Lock system comprising a wedge-shaped doorstop capable of locking in variable vertical pressure to lock a door.

FIG. 20 is another exemplary Add-Lock system, including a local authentication challenge GUI and key and keyhole mounting architecture.

FIG. 21 depicts an exemplary key guidance and keyhole protection device, that may be used with an Add-Lock system such as that discussed above, with reference to FIG. 20.

FIG. 22 depicts the same exemplary key guidance and door protection device discussed in reference to FIG. 21, in the process of being automatically centered and inserted into a keyhole by a human hand.

FIG. 23 is a schematic block diagram of some elements of an exemplary control system that may be used in accordance with aspects of the present invention.

FIG. 24 is an illustration of some exemplary user activities related to an Add-Lock system that includes a control system and wireless user activity monitoring and/or input.

FIG. 25 is an exemplary process flow diagram of exemplary steps that may be taken by a system, such as (but not limited to) a hardware and software control system of the nature discussed with reference to FIGS. 1, 20, 23 and 24, implementing aspects of the present invention.

FIG. 26 is another exemplary process flow diagram of exemplary steps that may be taken by a system, such as (but not limited to) a hardware and software control system of the nature discussed with reference to FIGS. 1, 20, 23 and 24, implementing aspects of the present invention.

FIG. 27 is another exemplary process flow diagram of exemplary steps that may be taken by a system, such as (but not limited to) a hardware and software control system of the nature discussed with reference to FIGS. 1, 20, 23 and 24, implementing aspects of the present invention.

FIGS. 28-39 depict a variety of GUI interfaces which may be manifested, for example, on the touch-actuable screen of a smartphone or other PDA, and may be used to implement aspects of the present invention in conjuction with a control system, such as (but not limited to) a hardware and software control system of the nature discussed with reference to FIGS. 1, 20, 23 and 24.

FIG. 40 is a perspective view of a key guidance and key-hole protection system that may be temporarily, and replaceably, mounted onto a key-hole.

### DETAILED DESCRIPTION OF THE INVENTION

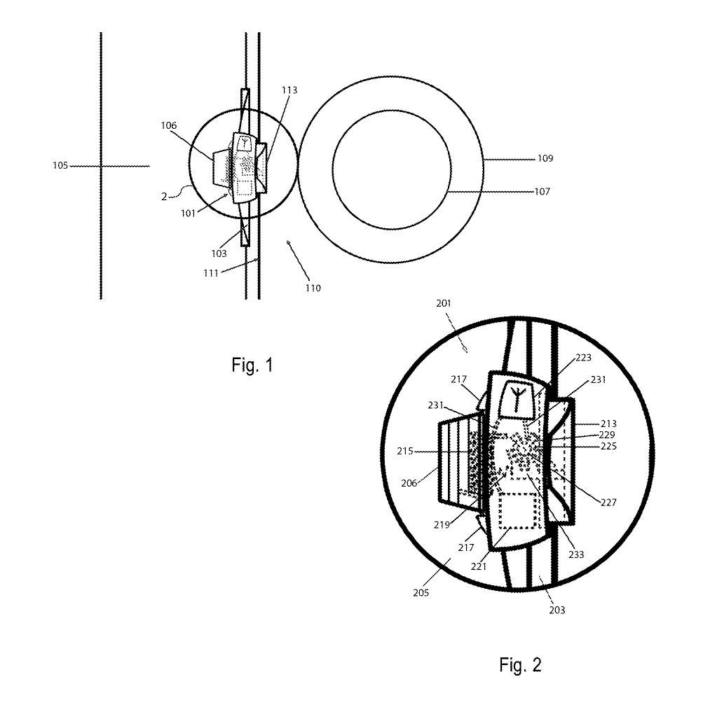

FIG. 1 is a side view illustrating part of a portable Add-Lock system 101 that may be temporarily installed onto a standard door and doorframe and locally or remotely actuated, for example, by radio frequency signals. In conjunction with a latch or tab (not pictured in this figure) that grips a mortise hole or other hole in a strike plate 103 or other latch-receiving hole of a door jamb 105, a strike plate-gripping tab 106 holds the system in place on doorjamb 105. Adjacent to the system 101 is a doorknob 107, with a stem (not pictured) mounted in a wider supporting bracket 109, both of which are mounted within door 110. Door 110 may be opened by a user such that its pictured vertical edge 111 swings toward a viewer of the figure. However, preventing that opening movement, for example, by an undesired intruder, and located on the other side of the door, is a user and/or system-controlled latch or other member 113, shown in its variable ejected (locking) position, in which it blocks the opening path of the door. In some embodiments, a user may simply press latch 113 inward (toward the main body of the system 101) to remove it from the pathway of the opening door, unlocking it. If a user so unlocks the door, the system 101 will remain in place mounted on the door jamb, but also may be quickly and easily removed (or put again in place) due to pivotable force-loading (e.g. a rotational spring) applied to strike-plate grabbing tab 106, creating gripping force, but also permitting the flexible disengagement of tab 106 from plate 103, as desired by a user. The force-loading, and manual or remote actuation techniques, are further illustrated below. The system 101 is shown within a view window 2, which is shown at greater magnification in the immediately-following figure. As also discussed in greater detail, below, an additional tab(s) or other gripping feature may hold the system 101 fast to the doorjamb, or to another feature fixed with respect to the doorway, creating locking structural force in reaction to unathorized attempts to open the door, when the system is in the locking position.

FIG. 2 is a portion of a view 2, previously shown within FIG. 1, but enlarged for magnification purposes. Rotational force-biasing spring 215 is now more easily seen, which tends to cause the strikeplate-gripping tab (now shown as 206) to rotate on hinges 217, bringing one of its edges toward (to enter and engage with) a gap between the strike plate 203 and the door jamb 205, gripping it. Additional linear force-biasing 219 is also shown, and tends to eject the system-controlled latch or member (now shown as 213) into its locking position, especially if the system is being operated in a manual mode, but, even in that event, the latch or member 213 may also be held in an unlocked position (or may be variably so held, for example, by a user-switchable holding tab that is not pictured) in some embodiments. But a user may, if desired, depress and unlock latch or member 213, compressing force biasing 219, if latch or member 213 is presently force biased or otherwise held by the system in the ejected, locking position.

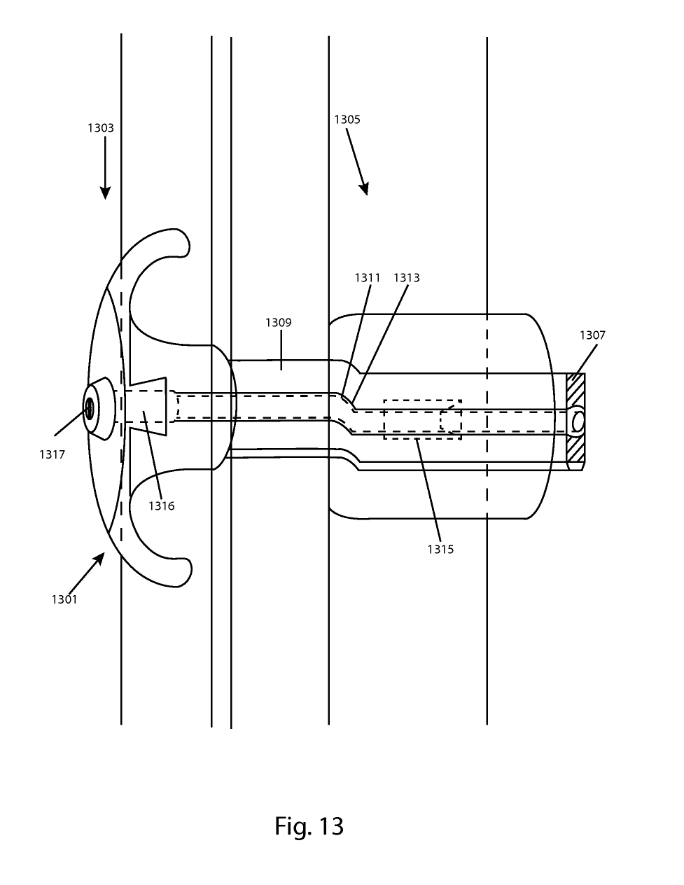

Alternatively, latch 213 may be unlocked by remote control, rather than manually. A control subsystem, such as a battery-powered computer system 221, may receive a command signal (for example, an RF signal) and otherwise give and receive signals through an onboard antenna 223, such that a user using an external command signal control unit (not pictured) may cause the system (now shown as 201) to actuate a sensor/motor 225 actuating a cog 227, with rail-interfacing gear teeth, such as that pictured as 229. Cog 227 and its teeth 229 may—if so commanded by an external control signal received by antenna 223, and transmitted, for example, by system busses or wires 231—drive rail 233 rightward or leftward, from the perspective of the figure. If a command signal is given and received to lock the door, the control system 221 interprets the signal and commands sensor/motor 225, if not already that position, to drive the rail 233 rightward. The rail 233, in turn, drives latch 213, to which its right-hand side is attached, rightward—into the ejected, locked position, if it is not already in that position. Conversely, if a user commands, using the same remote control unit, to unlock the door by sending a different command signal for that purpose, the control system 221 instead sends power to sensor/motor 225 to drive rail 233 leftward, to the unlocked position, if it is not already in that position. Aside from receiving such signals, interpreting them and translating them into sensor/motor commands, and issuing its own sensor/motor or other actuator commands (e.g., in timed or other conditional locking routines), the control system 221 may itself send signals to the external remote control unit, or another system, for example, sensing and reporting the locked or unlocked position of the portable Add-Lock system 201, for general and remote management purposes. The remote control unit, and/or such an external control system, may issue authorizations for local (e.g., near-field communication authentication passcode signals), to let particular licensed users of such near-field communication devices themselves actuate—including automatic proximity actuation—Add-Lock system 201. Alternatively, such local near-field communication devices or other key devices (such as “transflecters,” discussed further below) may be provisioned (including separate, traceable provisioning, which may be limited in time, or otherwise) with such authorization(s). In addition, as with all Add-Lock systems set forth in this application, manual control of locking and unlocking commands, the time and duration of such commands, and other actuation may be done manually (for example, by a user depressing or ejecting latch or member 213), or, alternatively or in addition, by a manual remote control GUI terminal, such as, but not limited to, the GUI terminal discussed with reference to FIG. 13, below.

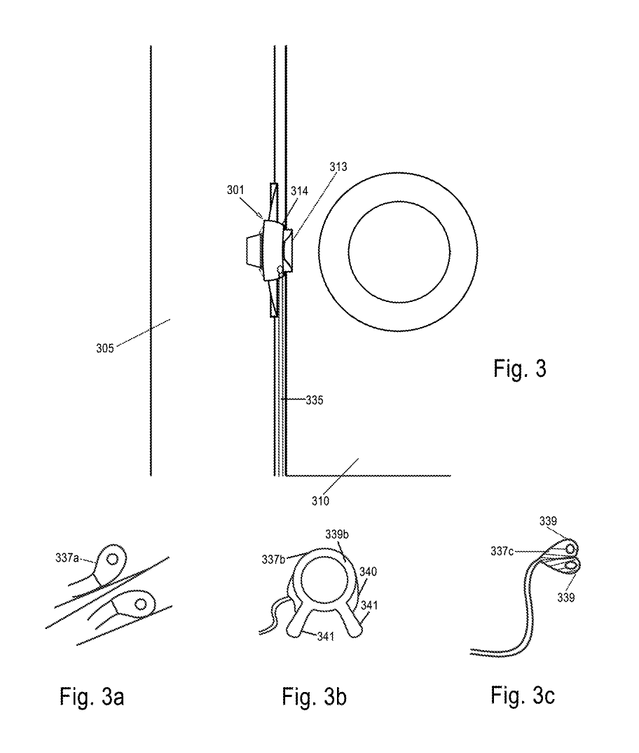

FIG. 3 is an illustration of the external appearance of the portable Add-Lock system of FIGS. 1 and 2 (now 301), from the same perspective as FIGS. 1 and 2, and also mounted in a doorjamb 305 and locking a door 310, as in FIGS. 1 and 2. From this perspective and simplified view, showing some outer-most physical components, one can see, among other things, that only a portion of system-controlled latch 313 is visible, even in the ejected, door-locking position (as pictured). The remainder of the latch 313, along with other mechanical components (such as gearing and force-biasing, not pictured), is retained within an outer housing 314, which is complementarily-shaped in comparison to latch 313, and only slightly (not more than 10-20%) wider, as necessary to house it and the remainder of the system components, depending on the embodiment.

Although remote-controlled (e.g., by RF-signal control unit) embodiments have been discussed, it should be understood that, in some embodiments, no remote control architecture is included, to simplify operation. Specifically, in some embodiments of the invention, the Add-Lock system 301 may be used exclusively by the occupant of the room, and no control by one outside the room is included. This may be preferable in some instances, such as when a single traveler will be present in a temporary room for the entire duration that he or she has a need to lock the room. In such instances, the added weight, expense and potential vulnerability to hacking by intruders is minimized. In some other embodiments, a physical remote control (e.g., a flexible pull cord 335 that causes the depression/recession of latch 313) may be included. For example, such a cord 335 may be sufficiently long to be accessible from a typical gap at the base of a door, and may include a facilitating handle such as any of 337a-c (e.g., comprising at least one loop-shaped or other handle-shaped object 339a-c partially-engagable even when laying on the floor in any position) that may be engaged by a slender protrusion introduced into that gap, for example, using a bent coat hanger. If only one such handle is present, preferably, the upward or other accessible orientation of that handle (as pictured) is encouraged, for example, by heavier weighting and/or other gravity settling-encouragement (e.g., rolling shapes 340) of a platform element(s), such as those alternatively pictured in FIG. 3b as 341. In this way, an emergency access or “knowledge-restricted” access may be granted to the room externally. However, as pictured in FIG. 3c, two or more such handles that may serve as both handle and platform may be used, or, as shown in alternative FIG. 3a, a handle may include a bend such that it is always accessible from the ground, to some degree when laying on a floor.

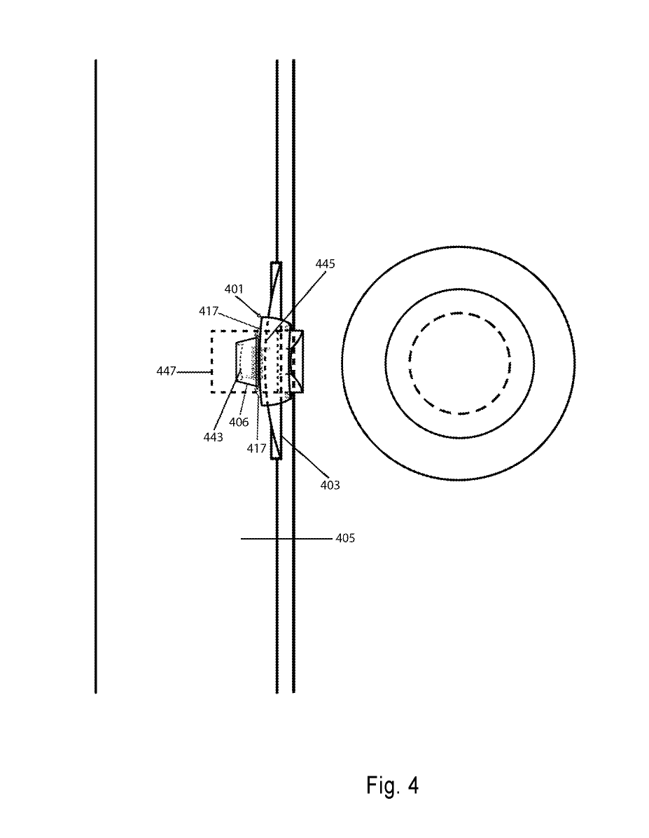

FIG. 4 is an illustration of additional aspects of the portable Add-Lock system of FIGS. 1-3 (now 401) and door jamb in which it is temporarily installed (now 405), from the same perspective as FIGS. 1-3. Additional details of the system 401 are now shown, including an inward-facing lip 443 of the strikeplate-gripping tab (now 406), which lip 443 may slide underneath the lip 445 of the strike plate, now shown as 403. More specifically, by pivoting around the axis of hinges 417, lip 443 slides inward along the door jamb 405 until it penetrates a gap between lip 445 and the door jamb, holding the system fast to the doorjamb. Although lip 443 is shown gripping the lip 443 of strike plate 403, it should be understood that such a lip may grip any available edge on the door jamb, including the outer edge of the door jamb itself. Similarly, although embodiments including a tab gripping a mortise or other latch-accepting hole, such as that shown as 447, are provided to secure a door in a locked position, in some embodiments, such a tab may grip the outer edge and/or surface of the door jamb itself (away from the viewer, into the page in the perspective of the figure). In still other embodiments, such a tab, or set of tabs, may variably grip one, any or more than one of several available edges for holding the system fast to the door jamb, or any other fixed, graspable aspect of a wall. As will be shown with reference to other figures, below, a wide variety of tabs and/or other mechanisms may also variably hold the system fast to the door.

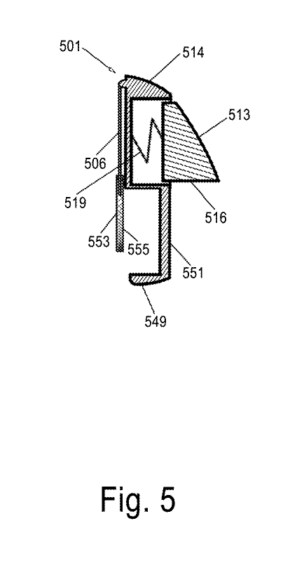

FIG. 5 is a side-view cross-section illustration of additional aspects of the portable Add-Lock system of FIGS. 1-4 (now 501) from a perspective rotated 90 degrees from that depicted in FIGS. 1-4, namely, from below, in reference to the perspective set forth in FIGS. 1-4. From this angle, the system-controlled latch (now 513) can be seen to include a substantially flat surface 516, for interfacing with and gripping the edge of a door, when ejected (in the locking position, as pictured). Alternatively, surface 515 may be barbed, concave or otherwise shaped to grip a door. Also pictured is an exemplary tab 549 that may insert into and hold the system 501 fast to a mortise or other latch-accepting hole, as mentioned above. As with surface 515, tab 549 may also be barbed, concave or otherwise shaped to grip the mortise or other latch accepting hole, rather than flat, as pictured. Tab 549 is attached to the system housing 514 via a strong, connecting section 551 via a substantially perpendicular (pictured) or barbed-angled joint. Connecting section 551, as with tab 549, is preferably constructed of a strong, solid substance, such as steel, but may also, alternatively, be semi-flexible with a high tensile strength. Also preferably, connecting section 551 is sufficiently thin (horizontally, in the figure) to permit fitting it between the door and door jamb of at least most closed conventional closed doors in residential and commercial buildings. Also pictured in FIG. 5 is another optional feature of the plate-gripping tab (now shown as 506). Specifically, tab 506 now includes an extension piece 553 which may close a vertical gap, if any (from the perspective of the figure) between the system and the doorjamb, assisting in holding the two fast, together. Force-biasing 555 tends to extend piece 553 from the remainder of tab 506, assisting in closing such gaps.

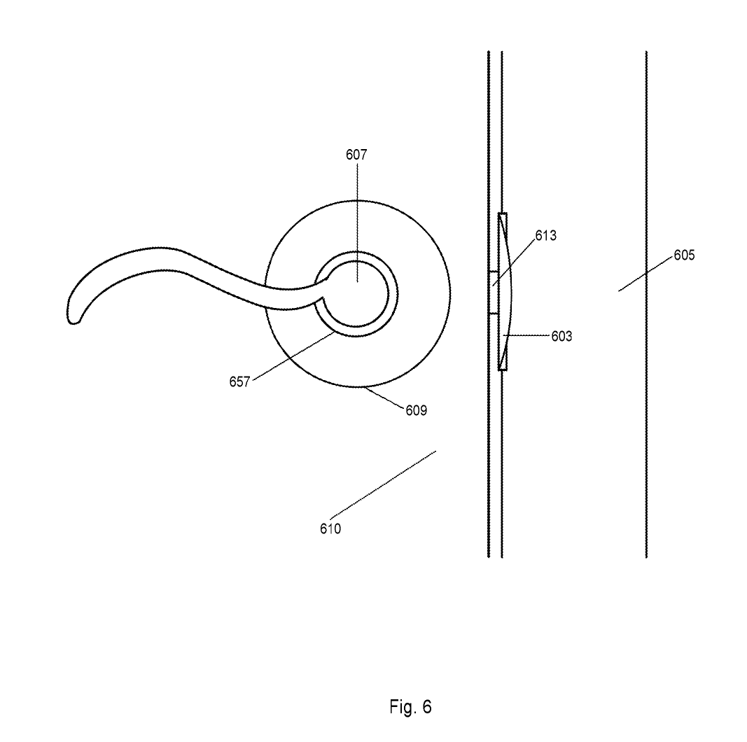

FIG. 6 is a front-view of a lever-style doorknob 607, door 610 and door jamb 605—in an opposing configuration from that pictured before. This illustration will serve as a platform and setting for discussing further aspects of the invention, set forth below. As with other illustrations, above, included are a strike plate 603, which may include a mortise or other latch-accepting hole (not pictured), and a latch 613. Also included is a doorknob stem 657 and door bracket 609.

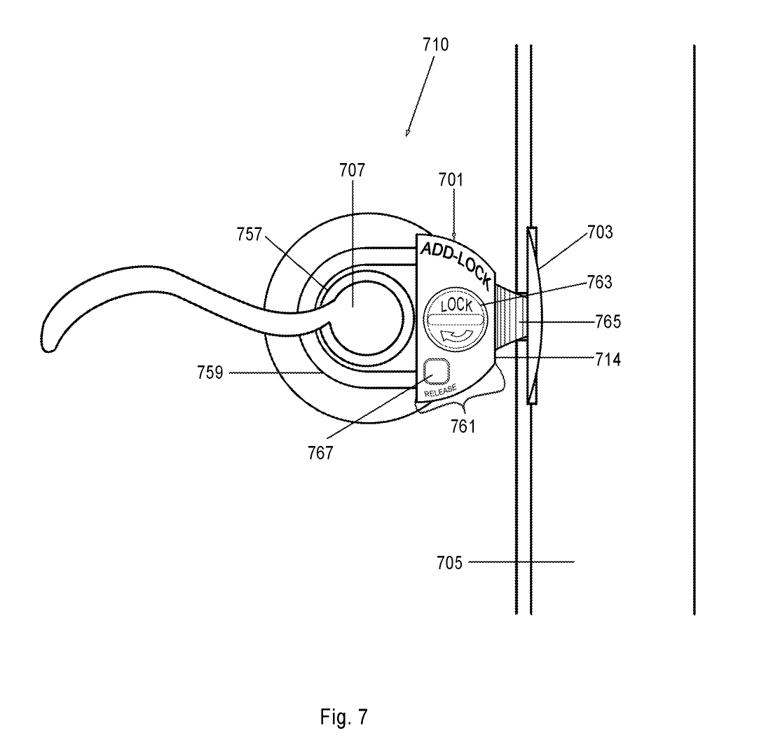

FIG. 7 is a front view illustrating aspects of another portable Add-Lock system 701 that may be temporarily installed onto a standard door 710 and doorframe—such as the door and doorframe set forth in FIG. 6. Unlike with the embodiments of Add-Lock systems set forth above, Add-Lock system 701 does not rely upon gripping the outer edge of the door to lock it in place against a door jamb. Instead, a loop or shackle 759 engages with the stem 757 of the door knob 707, holding the system fast to the door 710. A housing 714 contains a user-variable locking section 761 that variably engages with and holds the ends of shackle 759 when it has been placed around a stem 757. As will be shown in greater detail in reference to subsequent figures, a user interface aspect, such as locking, ratcheting dial 763, may serve to lock the shackle 759 in place, tighten (shorten) it, and/or tighten (extend or shorten, depending on the embodiment) an inserting tab 765, which a user may place within a mortise or other latch-accepting hole within door jamb 705, and, preferably, within strike plate 703.

When locked in the position shown in the figure, the system 701 holds the door 710 in a locked, closed position relative to door jamb 705. At the user's election, however, the system 701 may release the shackle 759 and/or the inserting tab 765, using, for example, release button 767, to halt application of locking structural force from the system 701.

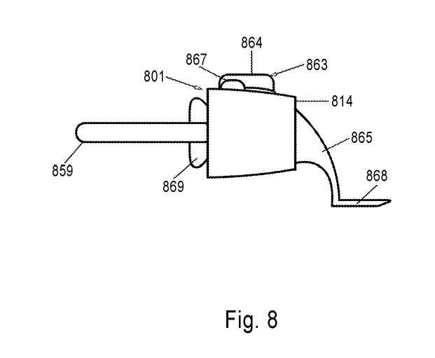

FIG. 8 is a side-view illustration of additional aspects of the portable Add-Lock system of FIG. 7 (now 801), from a perspective rotated 90 degrees from that depicted in FIG. 7, namely, from below, in reference to the perspective set forth in FIG. 7. From this perspective, the long, thin side profile of the inserting tab (now 865) can be seen. It is this low profile that enables tab 765 to fit between the majority of gaps between closed doors and their doorjambs in residential and commercial settings. A flat, barb-angled or curved tab section 868, which may variably interface with and hold a mortise- or other latch-accepting hole, is also shown better from the additional viewing angle of FIG. 8. In addition, one may see the raised, semi-rounded, semi-flattened profile of the release button 867, and a digit-actuable raised length 864, on the surface of the locking, ratcheting dial (now shown as 863).

Also shown in FIG. 8 is a new cushioning and space-filling body 869, which serves to prevent rattling between the shackle 859 and a door knob stem (not pictured in this figure) that it may surround, e.g., when locked in place, and may also serve to prevent scratching and other damage to the door knob and/or stem due to the application of force. Such cushioning bodies are preferably of a soft, elastomeric material that gives when encountering the harder substances comprising a door system. Such cushioning bodies may be placed in a variety of alternate or additional locations about the add-lock system (not pictured) such as, but not limited to, along the side of housing 814 facing the door, and along the face(s) of tab 865.

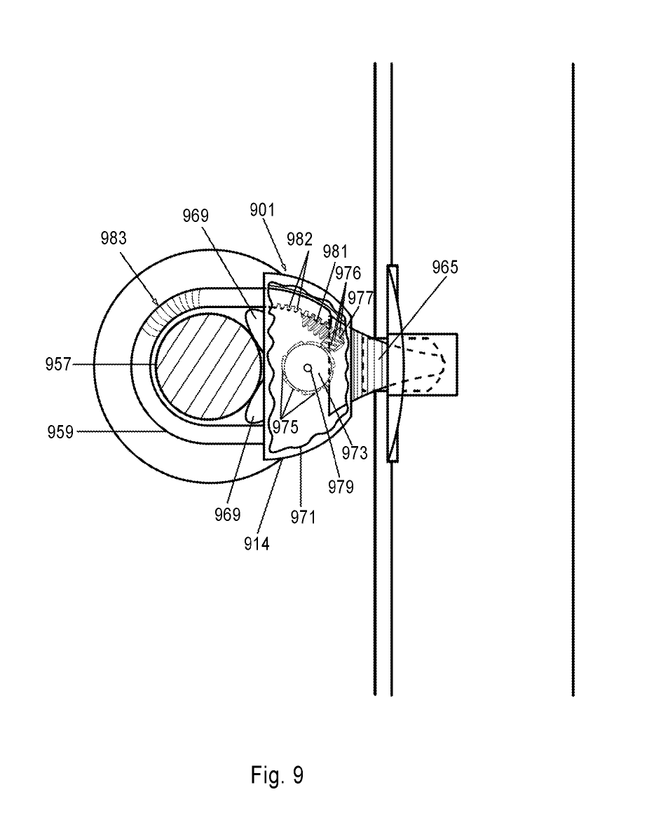

FIG. 9 is a front, partial cutaway view of the Add-Lock system (now shown as 901) discussed with respect to FIGS. 7 and 8, depicting additional aspects of the invention. More specifically, an exemplary embodiment of some internal workings of the Add-Lock system are shown, in a partial cutaway 971 of the housing (now shown as 914). For ease of visualization, the doorknob has been omitted, and just the stem of the doorknob 957 is shown, in cross-section. Through a cutaway 971, one may view a rotary gear 973 with gear threading 975, that may drive interfacing gear teeth (such as the gear teeth 976 of another lateral rotary gear 977) in either direction of the length of its axle/axis 979. For example, by spinning clockwise (in the perspective of the figure) in reaction to a user spinning a connected knob, gear 973 pushes its threading 975 into and against teeth 976, driving them in the direction into the page, because each thread member 975 rises out of the page along its length toward the clockwise side of its length, interfacing at a complementary angle with teeth 976, and pushing them inward (into the page). Thus, the result of a clockwise action in gear 973 is to spin lateral gear 977 counter-clockwise, from the viewing direction shown, or toward the shackle 959. A worm gear 981 is attached to and shares an axis with lateral gear 977. As gear 977 spins counter-clockwise, the teeth of worm gear 981 may interface with and pull inward-facing teeth 982 at the end of shackle 959, pulling shackle 959 tighter, securing it to stem 957. A separate advancing/retracting rail (not pictured) may also interface with gear 973, and (optionally) may be attached to inserting tab 965, causing its advancement and/or retraction (or a separate mechanism for that purpose may be used), as desired by a user for customizing and enhancing the fit of the Add-Loc system to a door and door jamb. A ratcheting mechanism (not pictured) or other holding mechanism may be included for rotary gear 973 or other components to variably hold them in position at any selected degree of turning or advancement. If a one-way ratcheting system, or other holding mechanism, is used, preferably, a release button is included to allow a user to disengage the mechanism and once again loosen or release the Add-Lock system. Although a plurality of teeth 982 are provided in FIG. 9, in some embodiments, it may be preferable to have a single tooth or notch, as in the instance of conventional pad locks, to facilitate the rapid attachment of the end of latch 959 into the housing 914. This rapid attachment may be further facilitated by an outward force-biasing of worm gear 981 that may be countered by insertion pressure, in the inserted direction only, for example, with the assistance of one-way (insertion only) gear-skip permitting gear shapes. Also although not pictured, a release button may permit the rapid disengagement of the worm gear 981 or other shackle retention or locking system, to rapidly release the shackle from the locked position. This role of the release button may be coupled with a role of releasing a ratchet and/or non-default extension position of tab 965, automatically restoring the default position (for example, if urged by force biasing).

In addition, some other new optional aspects of the invention are shown in FIG. 9. An embodiment with at least two cushioning and space-filling bodies 969 is shown. The bilateral, lobed shapes of these bodies are complementary to and conformable to the shape of most doorknobs and doorknob stems in residential and commercial settings, creating a seamless, rattle-proof interface, and preventing scratching from use of the Add-Lock system 901. Also illustrated is a new form of shackle 959, including a semi-flexible joint 983, which may enable a user to open a large berth in shackle 959, easing its placement around a doorknob stem 957. Preferably, semi-flexible joint 983 is semi-flexible in the sense that its rotary movement is restricted to one plane, and/or has outer limits to the permitted rotation to the point where it clears a maximum berth of the remaining, more rigid shackle bend. Also preferably, the joint 983 comprises a force-biasing that tends to open joint 983 to that maximum open rotation and berth.

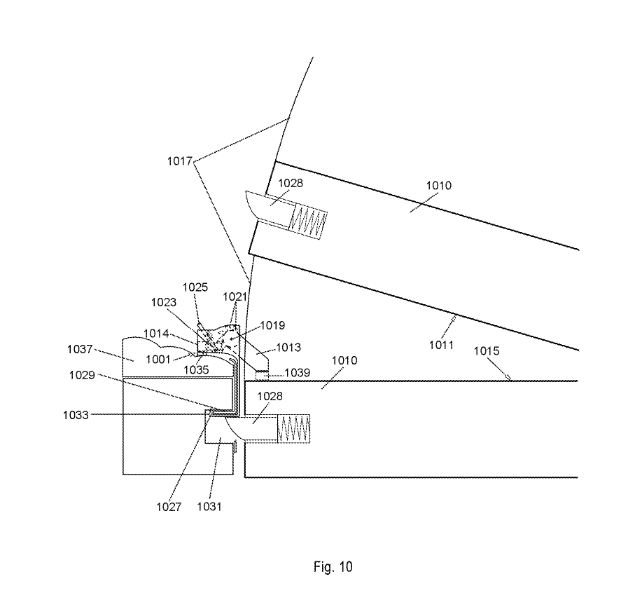

FIG. 10 depicts an alternative embodiment of an Add-Lock system 1001, in which a lockable rotary foot 1013 may directly engage with a door 1010 (shown in section to reveal latch and mortise detail) to variably lock it. The door 1010 is illustrated in both of two exemplary positions: (1) an open position 1011, and (2) a closed position 1015. The swinging path of the leading edge of door 1010 is also shown as path 1017. Foot 1013 is shown in a locked rotary position, in FIG. 10, holding door 1010 closed in position 1015. Foot 1013 may, under some circumstances, rotate freely in both directions about an axis 1019, but in the condition of the system 1001 shown in the figure, one-way rotation permitting teeth 1021 interface with a user-movable block mechanism 1023, which variably arrests counter-clockwise rotation (from the perspective of the figure) of foot 1013. However, even with the user-movable block in the tooth-interfacing, locked position shown, clockwise rotation (tightening, shoring up the locked position) is possible, due to the one-way skipping, ratcheting action of the rounded teeth 1021 against the block 1023. To permit door 1010 to open after being locked with the Add-Lock system 1001, a user may actuate a release/lock selection switch 1025, which may move block mechanism 1023 between a locking position (pictured), in which it interfaces with gear teeth 1021, and an unlocked position, in which the distal end of the switch (accessible by a user's fingers) flips to the right-hand side of the figure and disengages block mechanism 1023 from teeth 1021. In that latter, unlocked position, foot 1013 may freely rotate counterclockwise, and door 1010 may be opened, for example, toward the exemplary opened position depicted as 1011, assuming that all other necessary steps (e.g., retracting inherent door latch 1028 from a hole or mortise in a door jamb) are also carried out.

Additional aspects of an alternative embodiment for an Add-Lock system are provided in FIG. 10. For one, a wrap-around, barbed bracket 1027 attached to housing 1014 is shown engaged with the metal mortise and/or strike plate 1029 and/or other latch-accepting hole 1031, providing structural locking force for system 1001 and it's rotary foot 1013. Preferably, bracket 1027 is constructed of a strong, relatively rigid material, providing both adequate locking strength and limiting play to maintain its placement within the tight tolerances of most closeable swinging door doorways. Also preferably, a barb(s) 1033 at the tip of bracket 1027 extends beyond, or may be threaded beyond, the edge of most mortises and/or strike plates within a latch hole. That way, such barb(s) may penetrate and grip a neighboring material of the door jamb, if available, as well as gain a grip on the edge of the mortise and/or strike plate for increased strength and locking efficacy of the system. As mentioned elsewhere in this application, however, several other embodiments for gripping other available structural elements and parts of a doorjamb, or other parts of the doorway and/or surrounding wall(s) may, alternatively, be used in conjunction with the remainder of system 1001, instead of or in addition to, bracket 1027. Also as mentioned above, a number of different elastomeric, padded or other cushioning elements may be incorporated to avoid or reduce damage due to use of the system 1001. Shown in the figure are bumpers 1035 (protecting housing 1014 and doorjamb moulding 1037 from scratching or dinging one another) and 1039 (so protecting foot 1013 and door 1010).

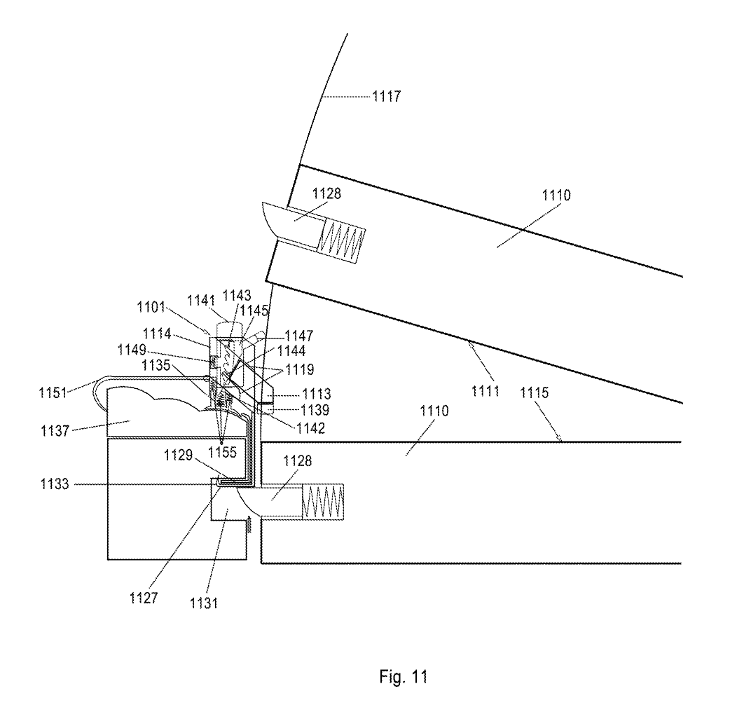

FIG. 11 depicts another alternative embodiment of an Add-Lock system 1101 comprising a sliding and variably locking foot 1113, which, as with the foot depicted in the system discussed with reference to FIG. 10, may directly engage with a door 1110 to lock it. As indicated, the chief difference from the embodiments set forth in FIG. 10 is the method of engagement of a door-stopping member, foot 1113. Rather than rotate away from door swing path to unlock and allow door 1110 to open and/or close, foot 1113 may slidingly eject from housing 1114 (in which it and other foot engaging and actuating parts are held), via ramped guides 1119. After installing system 1101, a user may press foot-ejecting (locking) button 1141, an internal ramped side 1142 of which variably engages with foot 1113 to eject it toward door 1110 when the door is in the closed position, 1115, and locking it closed. To aid in maintaining that locked position, a foot-retraction-preventing tab 1144, comprised in and at the foot-facing edge of ramped side 1142, may encounter any of a plurality of holding pockets, such as those examples shown as 1143, embedded in holding pocket strip 1145, also within housing 1114 and abutting the internal section of button 1141, including ramped side 1142. Holding pocket strip 1145, in turn, may be actuated by release button 1147 to variably release tab 1144 from pockets 1143, and permit foot 1113 to retract to an unlocked position, for example, with the aid of upward force biasing (not pictured, for simplicity). Aiding in restoring the locking position and ability of strip 1145 is a force-biasing 1149, which is counteracted by pushing button 1147. Additional upward, and preferably, also right-ward, force-biasing may tend to push button 1141 and side 1144 upward, releasing foot 1113, when 1144 is disengaged from pockets 1143 (by use of release button 1147).

Other differential features of the embodiments set forth in FIG. 11 include a door jamb/moulding wrap 1151, preferably of an at least partially flexible, force-biased and/or cambered material, which serves to conceal part of the mechanism of system 1101, and hold system 1101 in place, even when not locked onto a door, by actively pressing inward against the door jamb or its moulding 1137. A new form of cushioning piece 1135 is also provided, comprising a rubber, rubberized or other elastomeric cup (which may be a suction cup) 1153 and force biasing/spring(s) 1155.

As with other embodiments set forth in this application, any aspects may be interchanged with other aspects. For example, a radio frequency or other remote control, or system (e.g., timer) control may be added to actuate or obviate any of the user controls discussed.

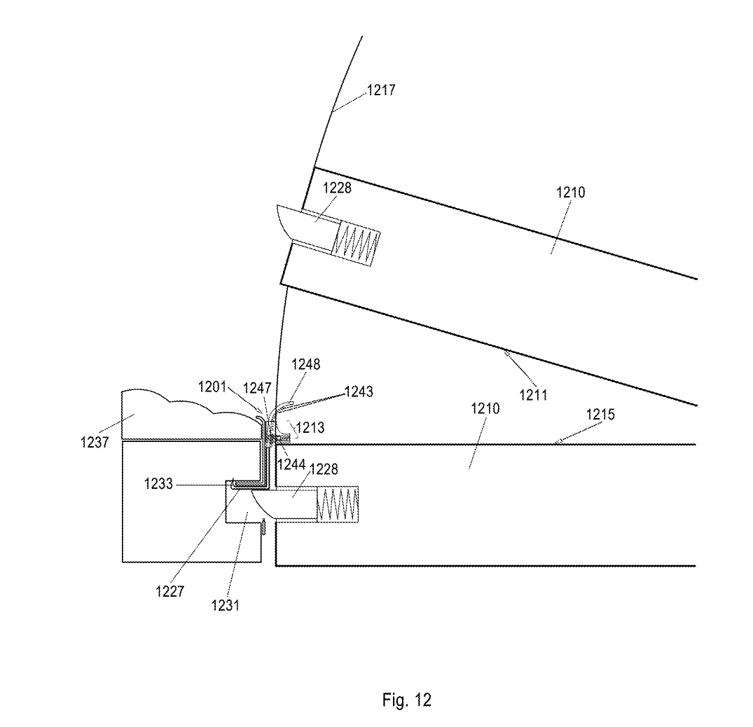

FIG. 12 depicts an Add-Lock system 1201 with a small profile and light weight, and many (though not all) important features of previous exemplary embodiments. Specifically, a combined door-stopping housing and tab 1213 may variably press against and hold door 1210 fast, locked in closed position 1215 by engaging with a zip line 1248 attached to the door jamb-holding bracket 1227. A plurality of one-way-slip enabling barbs, such as those examples shown as 1243, along the length of zip line 1248 permit housing/tab 1213 to shore up on zip line 1248, tightening and locking housing tab 1213 against door 1210. More specifically, when deployed (in the default, locking position) a forced-biased pin or other locking member 1244 is curved on one interfacing side and may move over barbs 1243 in one direction only (when housing/tab 1213 moves toward the door 1210 in locked position 1215), and a flat interfacing profile on the other side prevents opposing movement, holding the last, tightest position. To release the pin and untighten the system 1201 from the closed door 1210, a release tab 1247 counteracts tab 1244's force-biasing, retracting tab 1244 and allowing barbs 1243 to pass in the previously prevented direction with respect to housing/tab 1214, through which it is threaded. The zip line may be constructed of a strong, flexible material, which may be non-metallic and extremely light. Thus, the embodiment set forth in this figure is an excellent option for reducing travel weight.

FIG. 13 depicts a manual remote control terminal and GUI system (“control system”) 1301, which may be used in conjunction with a wide variety of Add-Lock systems discussed in this application. Although, as discussed throughout this application, user control of aspects of the invention may be carried out by unconnected remote (e.g., RF signal) transmission, in some embodiments, a physical connection for sending and receiving control signals, or even directly physically actuating control, may, alternatively, or in conjunction, be used.

In the embodiment set forth in FIG. 13, the control system 1301 is presented on the side 1303 of a doorway opposite another side, 1305, on which the remainder of an Add-Lock system (that may execute the locking of the door, e.g., with a physical door-holding member, as discussed in various embodiments above) is placed. For simplicity, and because a number of different Add-Lock Systems may be serviced by the control system, the remainder of an Add-Lock system controlled by the control system 1301 is omitted from FIG. 13, and a multivalent cross-section 1307 of a connecting strip 1309 is shown, unconnected to that remainder. Connecting strip 1307 is generally a rectangle mountable along the inside of a doorjamb (e.g., by a temporary adhesive lacing its side facing the doorjamb). Connecting strip 1307 has a width thin enough to fit between the gap between most residential and commercial closed doors and doorjambs. Connecting strip 1307 also preferably is flexible, such that it may conform to the variable contours (e.g., moulding, wood strips) of doorjambs and attached hardware.

Connecting strip 1309 comprises a central rotatable core 1311, passing through the length of the strip, and held within an outer shell 1313, in which it can rotate about its cylindrical center. In some embodiments, a lubricant between core 1311 and shell 1313 may be included, to facilitate its rotation. Also, in some embodiments, shell 1313 comprises a compression-resistant material, that nonetheless is flexible and turnable at least at points along its length (as in, but not limited to, the instance of a garden hose, with a coiled internal, flexible skeleton). Preferably, both core 1311 and shell 1313 are entirely comprised within the overall volume of strip 1309, such that the profile of strip 1309 maintains its distributed and even, low profile. The remainder of strip 1309 preferably also comprises an elastomeric material, resulting in a similar compression profile throughout the strip's width, or a graduated transition between such profiles throughout its width, to prevent excessive pressure at any point that may otherwise damage the door jamb and/or door. The central core 1311, as well as the strip 1309 as a whole, is depicted as traversing a latch-accepting hole 1315 and, as a result, blocking or resisting a latch from entering that hole. In this embodiment, the Add-Lock system may override a door's locking mechanism dependant on such a latch. However, as discussed further, below, in other embodiments, the central core and/or strip as a whole may circumvent a latch-accepting hole such as 1315, permitting the simultaneous use of the Add-Lock and conventional locking mechanism utilizing such a latch.

The rotation of the core 1311 within shell 1313 may be mechanically, electrically or otherwise translated into any number of Add-Lock actuation functions, such as locking the door with a rotating, sliding and/or projecting door-holding member, as discussed with respect to the many embodiments set forth elsewhere in this application. In some embodiments, core 1311 may be substituted with an electrical communication wire, and not rotate within shell 1311, simply transmitting actuation signals from the GUI to the remainder of the Add-Lock system, or, instead, wireless transmission of such signals may be used. However, to carry out the rotation of the central core, a turnable user interface aspect, such as a tumbler 1316 attached to a keyhole 1317, may be attached to the core. By inserting a fitting or authenticated key in keyhole 1317, a user may then turn tumbler 1316 and the attached core 1311.

As mentioned above, in some embodiments, a wired remote control system may be used, rather than a purely mechanical system. In such embodiments, a central wire in the same location as core 1311 may, instead, be used, and tumbler 1316 may comprise an electromechanical signal generator. In such embodiments, a purely electrical code driven user control may be used, instead of a turn-key mechanism, but a turn-key or other physical key may, also or alternatively, be used.

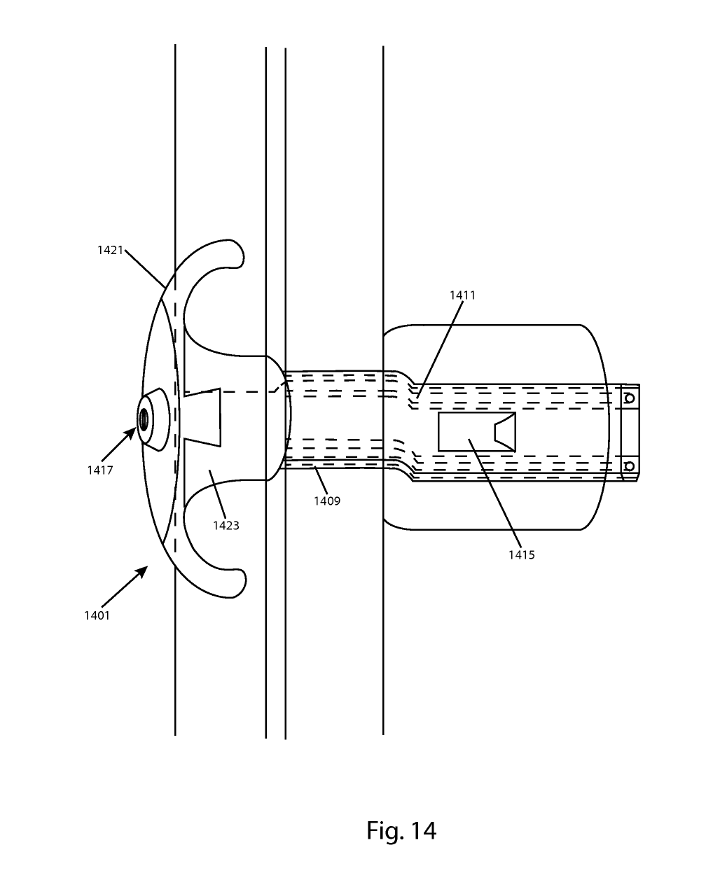

FIG. 14 depicts another manual remote control terminal and GUI system (“control system”) 1401, which, as with the system discussed with reference to FIG. 13, may be used in conjunction with a wide variety of Add-Lock systems discussed in this application. However, the system 1401 depicts alternative embodiment aspects. For example, rather than a rotatable core, system 1401 comprises at least one slidable mechanical core(s) 1411, which, unlike core 1311, may not be generally cylindrical, and need not be capable of rotation. Instead of using key interface 1417 to rotate a core, a user may, using the interface, instead disengage a handle piece 1421, attached to core(s) 1411, from the remainder of an outer housing 1423, which is attached to the remainder of strip 1409 (other than core(s) 1411). By pulling on handle piece 1421 when disengaged, a user can therefore pull core(s) 1411 toward him or herself, relative to other parts of the entire Add-Lock system and, in so doing, create mechanical force within that system to drive locking, unlocking and other Add-Lock mechanical actuation aspects, for example, by pulling a connected locking foot out of the way of a door path. As discussed above, however, a purely mechanical and mechanical force translation technique need not be used and an electronic or an electromechanical command translation may, instead, be used.

Also set forth in FIG. 14 is an embodiment where two cores 1411 circumvent a mortise or other latch-accepting hole 1415. Thus, as alluded to above, in this embodiment, a door latch and locking mechanism may be used simultaneously with the Add-Lock system.

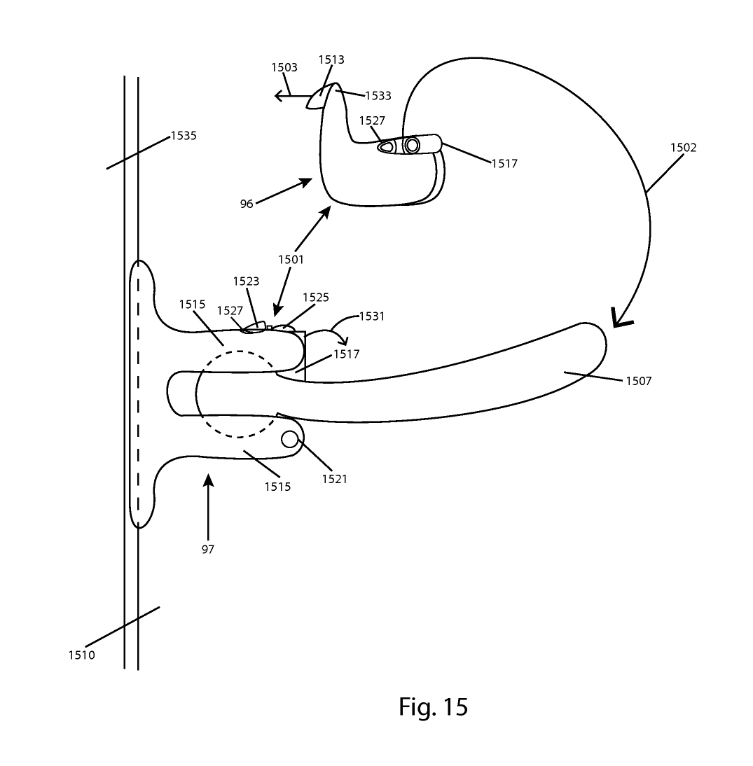

FIG. 15 illustrates an Add-Lock system 1501 which may be threaded over a lever-style doorknob to temporarily install it. This embodiment can be relatively light, portable, easy to manufacture, and may require very little maintenance. FIG. 15 presents system 1501 in two exemplary positions: (1) an un-installed side-view position 96; and (2) an installed, front-view position 97. The transition of system 1501 by user placement from position 96 to position 97 is demonstrated by movement arrow 1502.

System 1501 preferably is constructed, at least in part, of a strong, semi-rigid material, such as a high tensile strength polymer. A locking tab 1513, which, in some embodiments may be force-biased to extend outward (as pictured with force arrow 1503), into a space, if available, may be placed into a mortise or other latch-accepting hole of a door jamb (or other grippable aspect), to provide locking structural force for the system 1501. Interlockable arms 1515 may be threaded onto and/or placed over a lever style doorknob, as shown by position view 97. To prevent slippage from its position gripping lever-style doorknob 1507, and to provide additional locking structural force, a variable locking bar 1517 may be included, which may be placed between doorknob 1507 and the door 1510, for example, by swinging into a variable locking position about a hinge and pivot point 1521, at which point bar 1517 joins arms 1515 and locks the system 1501 to the door knob 1507. Aiding in variably locking/unlocking bar 1517 is a force-biased but depressible locking tab 1523, and an actuating button 1525 which is physically connected to and actuates, by user depression, locking tab 1523. By sliding into a channel (not pictured), locking tab 1523 is automatically depressed, owing to its rounded profile and depression-causing interfacing with a top ceiling of the channel, until it snaps into a hole in the ceiling 1527, at which point tab 1523 locks into place by rising back up. A flat or barbed rear edge to tab 1523 prevents release of tab 1523, and locks bar 1517 in place, until downward depression of button 1525 again permits the release of tab 1523. To facilitate rapid release, a force-biasing in the direction indicated by swivel motion arrow 1531 of pivoting release of bar 1517 may be included.

Although a variable locking member, such as bar 1517, may be used, in some embodiments, no such bar is used and, instead, a fixed loop passable around knob 1507 may be first threaded over knob 1507. Following that a user would then insert tip 1533 in between doorjamb 1535 and door 1510, and snap tab 1503 into the mortise or other latch-accepting hole in doorjamb 1535. To again release tab 1503 from that mortise or other latch-accepting hole and unlock door 1510, a separate button driving the variable retraction of tab 1503 may, instead, be used.

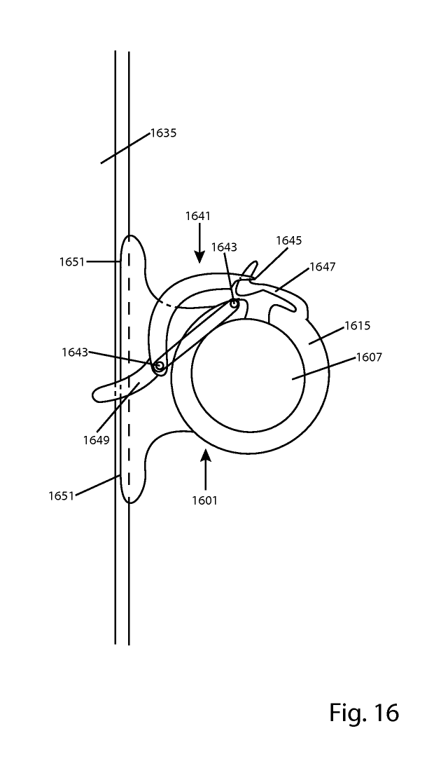

FIG. 16 illustrates another Add-Lock system 1601 which may be clamped over a more conventional doorknob, to temporarily install it. As with the system discussed with reference to FIG. 15, system 1601 may comprise a tip and tab (not pictured in this figure) insertable in between a doorjamb and door and into a mortise or other latch-accepting hole, respectively, to lock the system to the door jamb 1635. However, rather than arms for gripping a lever-style doorknob, a variably lockable clamp 1615 for gripping other forms of doorknobs is provided. Preferably, clamp 1615 may be wrapped about the outer surface of such a doorknob and includes a high-grip inner surface in contact with the doorknob when so wrapped. A variable clamp-tightening and/or locking mechanism, such as that demonstrated as swinging brace 1641, with pivot points 1643, locking loop 1645, hook 1647, and handle 1649, among other exemplary structural members, may be used. In addition, although not pictured, a variable clamp width or circumference extender/shortener may also be included, to custom fit system 1601 to a wide variety of available doorknobs. In some embodiments, an inserted tip and edge 1651 may prevent twisting of doorknob 1607, and a separate latch-hole interfacing tab may even be omitted—the system 1601 relying instead on the existing latch of the door. In other embodiments, clamp 1615 may be fastened to a doorknob stem or other structural door feature, instead of the doorknob itself.

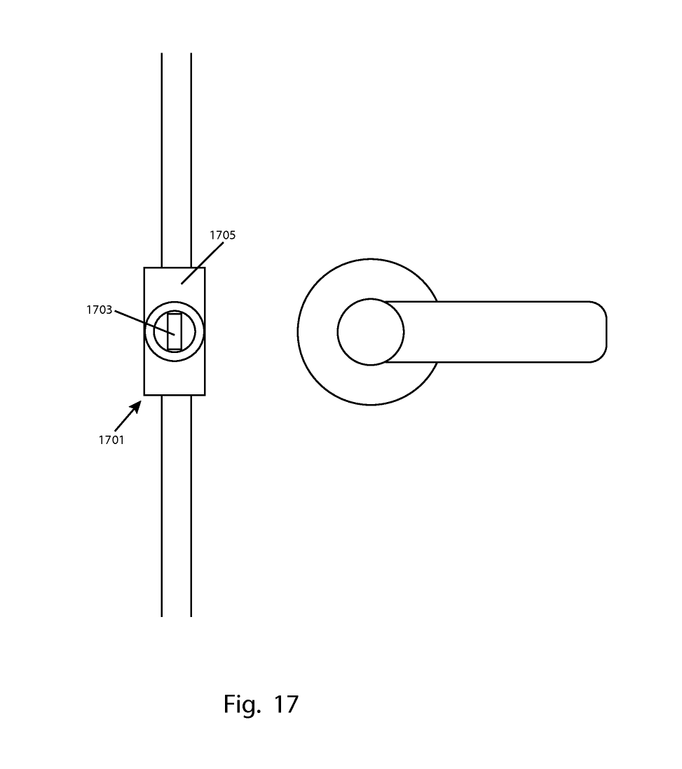

FIG. 17 demonstrates the potential outward appearance (from the perspective of a person on the outside of a locked space, such as a room, of a potential manual remote control terminal and GUI system 1701, such as those discussed with reference to FIGS. 13 and 14. From this perspective, very little hint of the structure or form of the Add-Lock system is provided. Instead, a person locked out of a room by an Add-Lock system, who may, if properly authenticated, use the GUI simply sees a standard keyhole 1703, and a surrounding housing 1705.

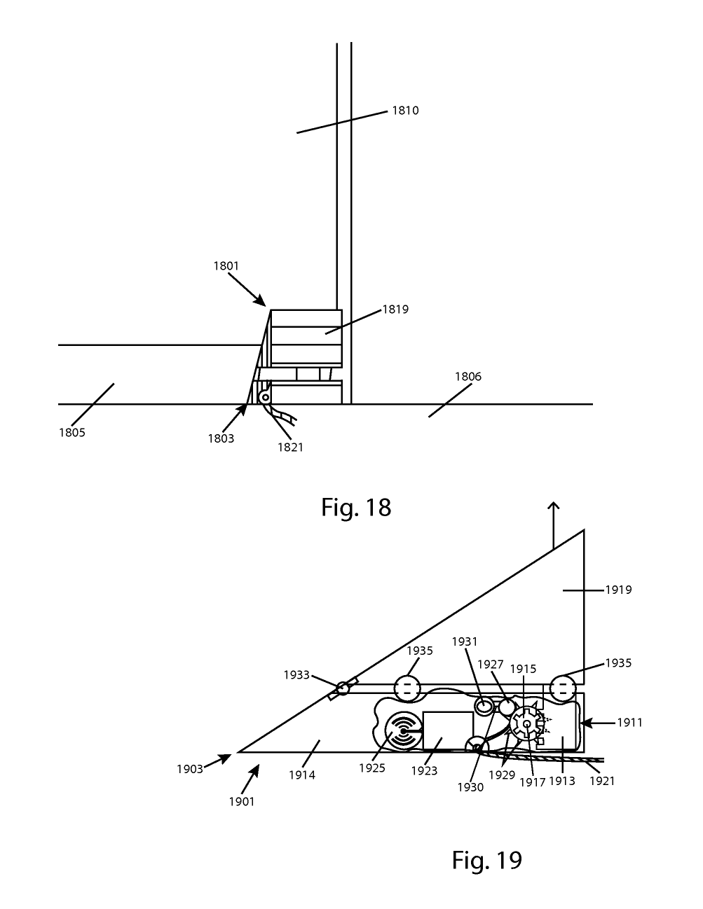

FIGS. 18 and 19 provide a back perspective and side view, respectively, of another alternative embodiment of an Add-Lock system 1801/1901, comprising a wedge-shaped doorstop capable of locking-in variable vertical pressure to lock a door, shown as 1810.

As with other, conventional wedge-shaped doorstops, a user may insert the tip 1803/1903 of system 1801/1901 into a gap 1805 between the door 1810 and a floor below it, 1806, to place it in service holding a door in place. However, a conventional wedge-shaped doorstop, while often sufficient to prop a door open and free a user's hands while entering a doorway, generally will be insufficient to secure a door against unwanted intrusion. Most intruders, of typical human strength, will be capable of overcoming the structural resistance of a conventional doorstop (even if strongly manually wedged by a user) simply by pushing vigorously inward, against the outer face of an inward-swinging door. To create sufficient securing pressure, system 1801/1901 comprises a vertical pressure varying mechanism 1911, capable of increasing the vertical (upward) pressure applied by the system against the rear surface of the door 1810.

In greater detail, an exemplary vertical force increasing mechanism is illustrated, and comprises a geared jacking member 1913, which may be driven upward by a ratcheting cog 1915, which rotates about an axis 1917 fastened into the structure (e.g., housing 1914) of system 1801/1901. As member 1913 is driven upward, it, in turn, may drive upper door contact section 1919 (to which its top is attached) upward, and apply increased locking pressure against the bottom of the door. Cog 1915 may be driven in the counterclockwise rotational direction about axis 1917 by a high tensile strength line 1921 which so drives cog 1915 when pulled with sufficient strength, being tied to or otherwise attached to and drivably wrapped around axle 1917, or, preferably, a wider hub or reel rotationally locked to it (not pictured). Although not pictured, additional mechanical systems for increasing leverage and other mechanical advantage may also be used, to ease a user's application of increased vertical pressure with the system 1801/1901. In addition, or alternatively, a variably actuable sensor/motor (not pictured) and remote control (e.g., RF signal) subsystem 1923 may be used to either lock, release, or perform any other actuation tasks for the system 1801/1901. Such a system may receive remote control commands, and send useful information (e.g., compromised strength, break-in, or attempt warnings (based on disruption) and gather data based on such attempts (e.g., time and date, force encountered, camera picture of intruder, via a camera snaked out of and under the door through gap 1805), current pressure exerted and locking force status) via a transceiver and/or antenna 1925.

As locking pressure is increased by cog 1915, that pressure is variably locked in by a pressure retention member 1927, which may be encouraged to interface with, and hold, pressure retention barbs, such as those examples pictured as 1929, on (or on a gear associated with) cog 1915 via a force-biasing, such as spring 1930 and guiding channels (not pictured). However, a user may release vertical pressure by disengaging retention member 1927 via a release switch 1931, or, as discussed above, via a remote-control system (e.g., encrypted web-based user actuation portal in communication with subsystem 1923 via antenna 1925—e.g., WiFi—or local application run in a PDA with Near-Field Communication).

In the embodiment pictured, a hinge 1933 aids member 1919 in exerting upward vertical pressure by easing the pivoting motion of section 1919. In other embodiments, however, section 1919 and the remainder of the system are constructed of materials comprising one, semi-flexible housing or other structure. Such an embodiment may be easier or less costly to manufacture. Similarly, another useful feature that may be more costly to produce is a number of cushioning member(s) 1935, which prevent self-damage to, and potential actuation noise from, system 1801/1901. A pivoting joint may also be included at the connection between member 1913 and section 1919.

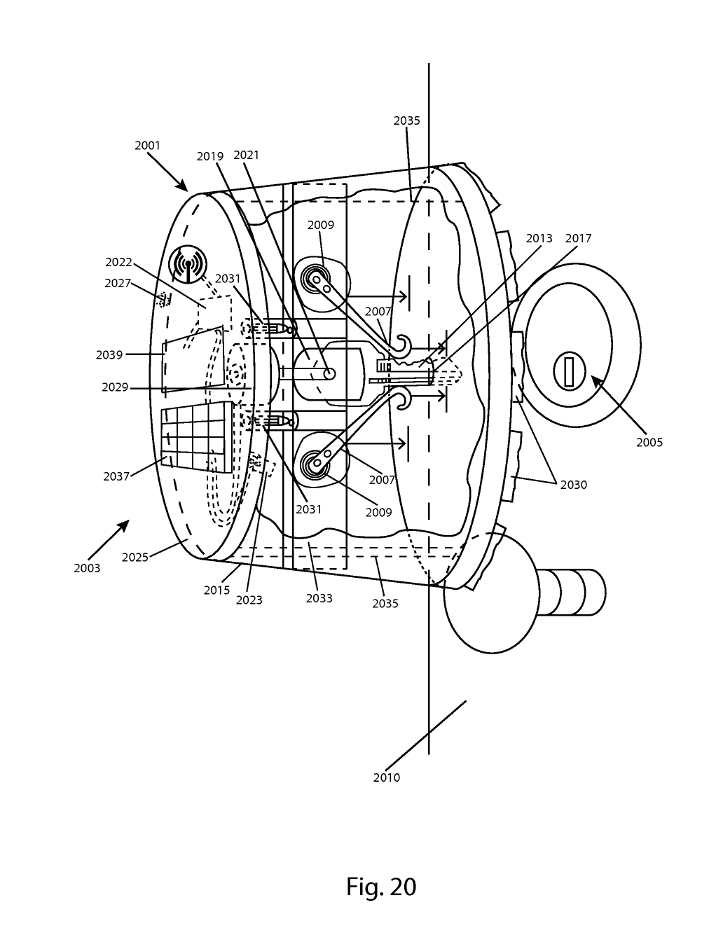

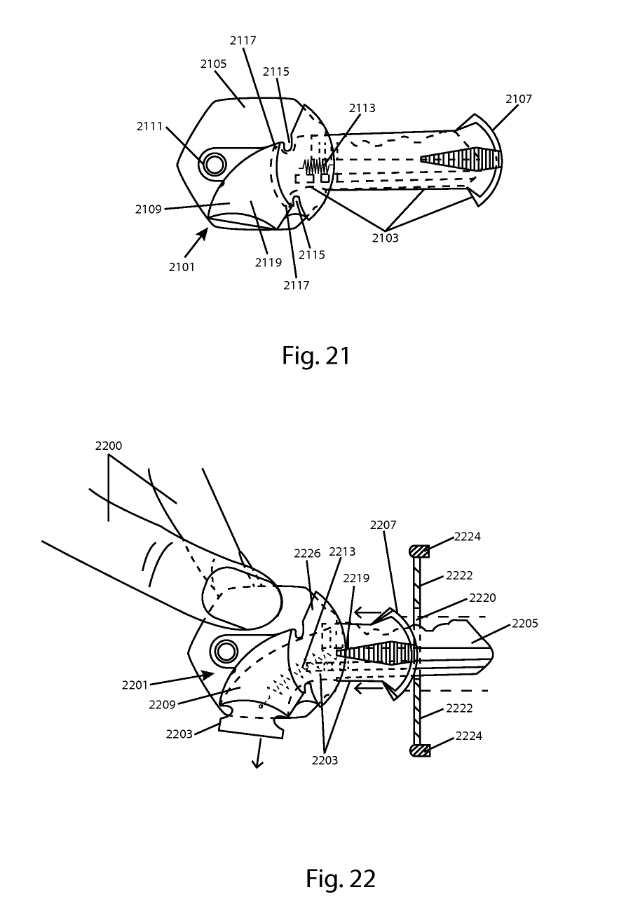

FIG. 20 is another exemplary Add-Lock system 2001, including a local authentication challenge and command GUI 2003, and a key- and keyhole-mounting architecture. As with some other Add-Lock devices discussed in this application, system 2001 may be variably, non-damagingly mounted to an existing door with a built-in, keyed lock, in either a locked or unlocked condition of the door. Thus, a keyhole and surrounding bracket 2005 for actuating such a doorlock in a door 2010, are also pictured. To utilize the system 2001, a user may install system 2001 to the doorlock by mounting securing pieces, such as pivoting, gripping hooks 2007, to the insides of keyhole and/or bracket 2005. Preferably, hooks 2007 are force-biased (for example, by springs 2009) or system-actuable (e.g., by system-controlled hook rotational actuators, not pictured but at the same position as 2009) to pivot outward to a rotational limit, away from one another, such that, as a user presses system 2001 toward door 2010 and doorlock keyhole and bracket 2005, hooks 2007 are then pressed inward, against their force-biasing, until they snap into place, gripping the insides of the keyhole and/or bracket 2005. At that point, force-biasing 2009 causes hooks 2007 to grip the keyhole and/or bracket, and hold system 2001 fast against door 2010. System 2001 also may variably grip an interchangeable and variable key, 2013, which may variably (and user and/or system-actuably) extend from the housing 2015 of system 2001 through a key extension hole 2017. First, to equip the system 2001 for installation/mounting onto a door, a user may select a door and doorlock for installation of the Add-Lock system, and locate or create a key, such as key 2013, that fits and may be used to unlock the doorlock through keyhole and bracket 2005. The user may then place key 2013 into a key-gripping rotator 2019 that, preferably, variably locks onto the key, for example, through the keychain hole at the proximal end of the key with a suer and/or system (e.g., threading after key presence detection) variable pin 2021. An additional key- and key-hole protecting and guidance device (not pictured in the figure) may be added to rotator 2019, or to the key itself. Such a device is discussed in more detail with reference to FIG. 21, below.

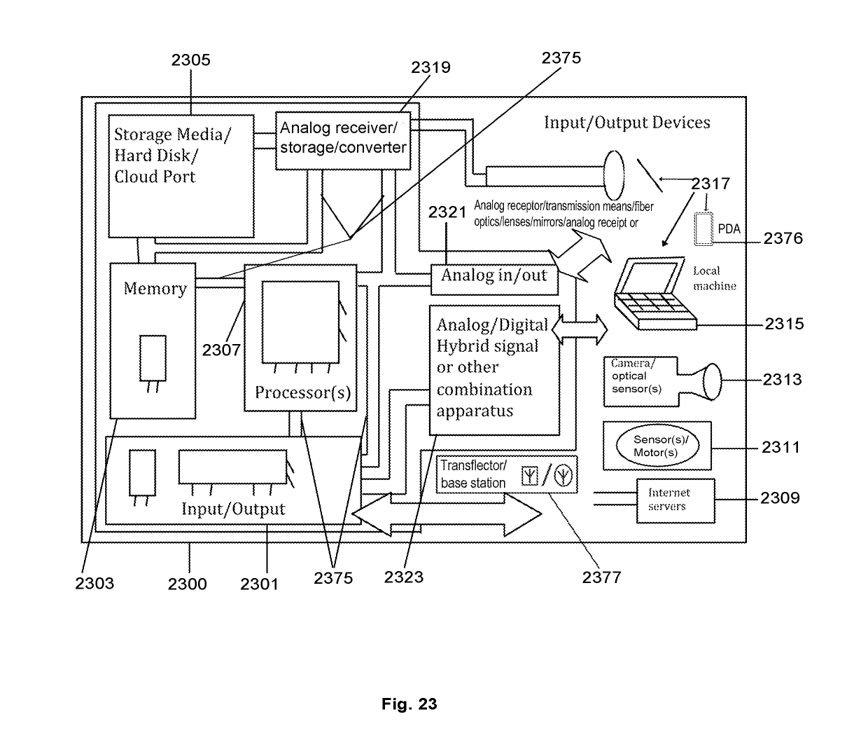

To access the rotator 2019, and so install the key 2013, a user may variably open a housing door lock 2023, such that a housing door, such as door 2025, may open (for example, swinging on hinge 2027). As pictured, such a housing door lock 2023 may include actuators networked or electronically connected to a control system 2022, such that a user may, using GUI 2003, unlock and open a housing door to install and uninstall key(s). For example, a password challenge followed by control commands (each controlled by the control system, hardware, software and the GUI) to open housing door lock 2023 and housing door 2025 could be used for that purpose. An exemplary control system for this and other GUI, control, network and actuation purposes is discussed elsewhere in this application, in reference to FIG. 23.

After installation, key 2013 may be fully inserted into keyhole and bracket 2005 by or with the aid of the system 2001, while system 2001 remains mounted onto the doorlock. In addition, system 2001 may actuate key 2013 in the doorlock, by causing it to turn in the unlocking rotational direction, by actuating a rotary motor 2029, connected to key-gripping rotator 2019. For example, control system 2022 may receive a command from the user (e.g., wireless network and/or GUI command) and/or system (e.g., time-controlled unlocking with the use of a timing circuit and/or program) to unlock door 2010 and, if the command is properly authenticated, cause key 2019 to rotate in keyhole and bracket 2005, unlocking door 2010. To create foundational grip for the system against door 2010, and drive that rotation, gripping feet such as those shown as examples 2030 (preferably composed of a sticky elastomeric material) on the side of housing 2015 facing door 2010 may be included which, due to pulling pressure from hooks 2007, are held firmly against door 2010, gripping it. As an added benefit, feet 2030 also cushion the system and door, preventing them from scratching one another. To cause key 2013 to variably extend from hole 2017 and into a keyhole, extension actuator(s) 2031 may variably drive a slidable scaffold 2033, on which the entire key-gripping and turning machinery are mounted, along/within rails 2035, until key 2013 is fully inserted into the keyhole and bracket 2005, on which the system 2001 is mounted.

Conversely, the system may use the extension actuator(s) 2031 to move scaffold 2033 and key 2013 in the opposite direction, retracting key 2013 into the housing—for example, for security purposes and/or when tampering is detected. To illustrate—if the system detects tampering by an unauthorized user (for example, by the rotation of housing 2015 prior to passing a password challenge in an illegal attempt to turn the key in the lock or rip off system 2001 from its mounting, the control system may automatically and immediately so retract key 2013 into its locked housing 2015, where it is inaccessible by such an unauthorized user. The system may also take violator-identifying data, such as pictures with a networked camera or DNA samples, sound an alarm, alert authorities or the user (e.g., by a PDA software and/or hardware application) mark those in the vicinity during such a violation, for example, with a phosphorescent paint. Alternatively, the key may be held in a fixed, always inserted, position, and retractors 2031 and the scaffolding 2033 and rails 2035, may be omitted, but an alternate mounting device(s) should then be used—for example, straight members that convert to hooks upon insertion, rather than hooks 2007, or other mechanisms used for mounting Add-Lock systems onto doors discussed in this application.

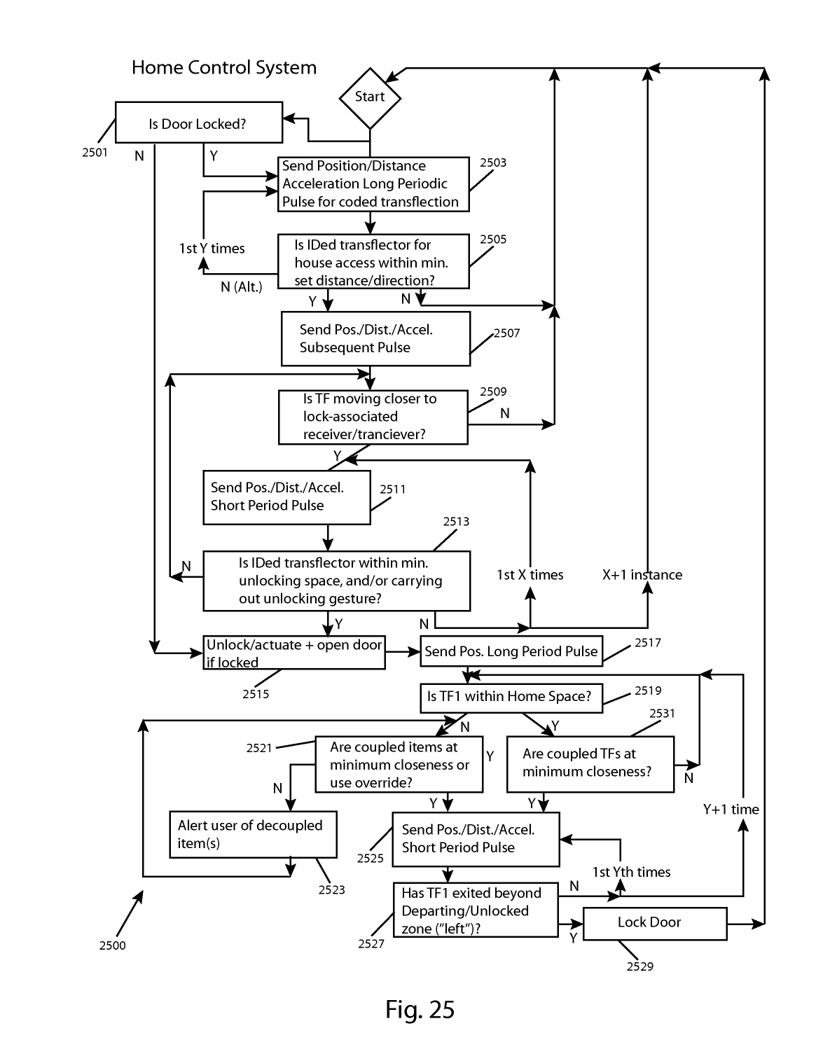

To aid in user commands and authentication, a local GUI 2003 may include a user input device, such as an alpha numeric keyboard 2037, and an output display, such as LCD 2039, may be used. However, as mentioned elsewhere in this application, the methods, systems and devices carrying out the present invention need not be locally, or completely locally, carried out and at least some aspects may, instead, be carried out on remote control systems that are networked, variably networked and/or partially networked, through wireless, wired and/or other networking and communications techniques. Any wireless transmissions should be conducted with secure encryption covering all such transmissions and, preferably, with different encryption for each such transmission pathway and transmission instance to thwart hacking attempts. The control subsystems at each broadcast and receipt location can cycle, seed and source new encryption cyphers, algorithms, layers and/or other encryption tools such that both locations share the same, changing encryption or set of possible decryptions (and possible selection system or method for such a set), for each transmission. If a networked approach for at least partial actuation and/or control of an Add-Lock system is used, a remote control GUI and terminal may be used (for example, a GUI created on an application running on a PDA, smartphone or other networked device for control input/output, such as those discussed further, in reference to FIGS. 25-39, below).

In some aspects of the invention, the entire system 2001 may take on alternate forms, with alternate grabbing and holding devices that variably mount the system 2001 onto a wide variety of manual lock actuators, in addition to conventional keyholes. For example, such a modified system 2001 may be placed on the inside of doors such as that pictured as 2010 to actuate door handles, latch switches, or any other such manual control for locking, unlocking, opening and closing a door, or otherwise actuating housing and personal effects. For example, modified hooks or a pair of inward-angled (toward the door and a central part of the switch) combs or blades with thin edges may be placed around, slip under and grip a latch switch. Rather than be rotated to mount, such as with hooks 2007, such switch-gripping combs may be converged toward one another, until establishing grip and, by threading under the surface of the switch or knob facing the door, hold the system in place against the switch and door while retaining the grip to actuate them (e.g., by system-actuated and directed unlocking rotation of a latch switch, so held). Similar gripping combs or hooks may be used to actuate car door switches, but may be threaded into the cracks or tolerances between such switches, and hook around the far side of the switches more deeply, to mount the system. The overall systems may need to be of a different shape and size, and incorporate manual or other, system-managed remote controls, as set forth elsewhere in this application, to fit the door or other actuable item in question and be controlled by a user.

FIG. 21 depicts an exemplary key guidance and door protection device 2101, that may be used with an Add-Lock system such as that discussed above, with reference to FIG. 20. The system comprises at least one slidable protective projection(s) 2103, that, in the extended, protecting position (pictured), guards at least some hard edges and points of a key 2105 to which the system is attached. In addition, projection(s) 2103 comprise a sloped, protecting and/or convex tip(s) 2107, which may smoothly engage with, and guide the attached key into, a keyhole (not pictured in this figure), while protecting both the key and keyhole from, among other things, scratches. A range of pressures and misalignments of key 2105 will be automatically channeled into a keyhole by the tip(s) 2107, owing to its smooth, convex slopes. In addition, the smooth, convex slopes will not scratch outer surfaces of such a keyhole, surrounding bracket, or other aspects of the surrounding door, vehicle or building. And the guarding aspect of the extended projection(s) helps prevent the key itself from so scratching those, and other, items. Finally, the guarding projection(s) prevent the attached key from rattling against other keys and objects, for example, on a common keychain and/or in a user's pocket, preventing noise. Slidably-engaged with, and partially holding projection(s) 2103 in the extended position is key-mounting housing 2109. Housing 2109 is variably fastened to key 2105 via key-ring hole penetrating snap 2111, which, preferably, is hollow in the snapped in (key conjoining) position (pictured), such that a key-ring or other device may still be threaded through the center of the key-ring hole. Although a key-ring hole fastening snap or holder is pictured, any number of alternative brackets, clips or other variable holding devices may, instead or in addition, be used to conjoin housing 2109 and key 2105. For example, as one such alternative, the housing may also surround and grip a substantial portion of the key body, for example, by being at least partially composed of an elastomeric material, stretched over and onto the key, rather than penetrate or even partially block the key hole.

The housing may contain a force-biasing, such as spring(s) 2113, that tend to push projection(s) 2103 outward, (into the position shown) fully covering the tip of the key 2105 with projection tip 2107. At least one retention tab(s) 2115, however, prevent the total escape of projection(s) 2103 from housing 2109 by stopping matched retention tabs 2117 at the proximal end of projection(s) 2103. The faces of tabs 2115 and 2117 that face one another at the proximal end of projection 2103 are preferably flat, barbed or otherwise mutually holding, leading the tabs to grab one another, preventing the escape of projection(s) 2103. However, when pushed in the proximal direction (for example, by insertion into a key hole) the semi-flexible nature of projection 2103 and its tabs, and the curved sides of the tabs facing one another at the more distal side of the tabs, allow the retraction and redirection of projection(s) 2103 into a tunnel 2119 within housing 2109. This retraction action will be better demonstrated, below, in reference to FIG. 22.

FIG. 22 depicts the same exemplary key guidance and protection device (now 2201) as that discussed in reference to FIG. 21, in the process of being automatically centered and inserted into a keyhole 2220 by a human fingers 2200, gripping the key 2205 and device housing 2209. As key 2205 is inserted into keyhole 2220, projection(s) 2203 are pushed into housing tunnel 2219. As a result, key 2205 is increasingly exposed as it is inserted, but only insofar as it is inserted, into keyhole 2220, further preventing errant scratching of keyhole 2220 or its surrounding faceplate 2222 and bracket 2224, and force-biasing spring(s) 2213 is/are extended, storing potential energy for covering key 2205 once again, if and when it is pulled back out of key hole 2220. If sufficiently inserted, key 2205 completely enters keyhole 2220, to the same extent as if no protection device 2201 were present, because projection tip 2207 may enter a complementary pocket 2226, completely clearing it from the fully-inserted region of key 2205.

Although key guidance and door protection device 2201 is shown as it may be actuated by a human hand, it may, alternatively, be actuated by insertion of an attached key by another device and/or system, such as the system discussed in reference to FIG. 20, above. In fact, such a key-gripping housing such as that discussed in FIGS. 21 and 22 may be integrated with the key-gripping rotator 2019 of FIG. 20, for that purpose.

FIG. 23 is a schematic block diagram of some elements of an exemplary control system 2300 that may be used in accordance with aspects of the present invention, such as, but not limited to actuating sensor(s) and/or motor(s) for locking and unlocking doors, sending alerts and other communications, sensing user or person's behavior, provisioning user settings and permissions, and receiving control commands and managing input interfaces, such as, but not limited to a GUI, as defined and discussed elsewhere in this application. The generic and other components and aspects described herein are not exhaustive of the many different systems and variations, including a number of possible hardware aspects and machine-readable media that might be used, in accordance with the present invention. Rather, the system 2300 is described to make clear how aspects may be implemented. Among other components, the system 2300 includes an input/output device 2301, a memory device 2303, storage media and/or hard disk recorder and/or cloud storage port or connection device 2305, and a processor or processors 2307. The processor(s) 2307 is (are) capable of receiving, interpreting, processing and manipulating signals and executing instructions for further processing and for output, pre-output or storage in and outside of the system. The processor(s) 2307 may be general or multipurpose, single- or multi-threaded, and may have a single core or several processor cores, including, but not limited to, microprocessors. Among other things, the processor(s) 2307 is/are capable of processing signals and instructions for the input/output device 2301, analog receiver/storage/converter device 2319, analog in/out device 2321, and/or analog/digital or other combination apparatus 2323 to cause a display, light-affecting apparatus and/or other user interface with active physical controls (any of which may be comprised in a GUI) to be provided for use by a user on hardware, such as a personal computer monitor or PDA screen (including, but not limited to, monitors or touch- and gesture-actuable displays) or terminal monitor with a mouse and keyboard or other input hardware and presentation and input software (as in a software application GUI), and/or other physical controls.

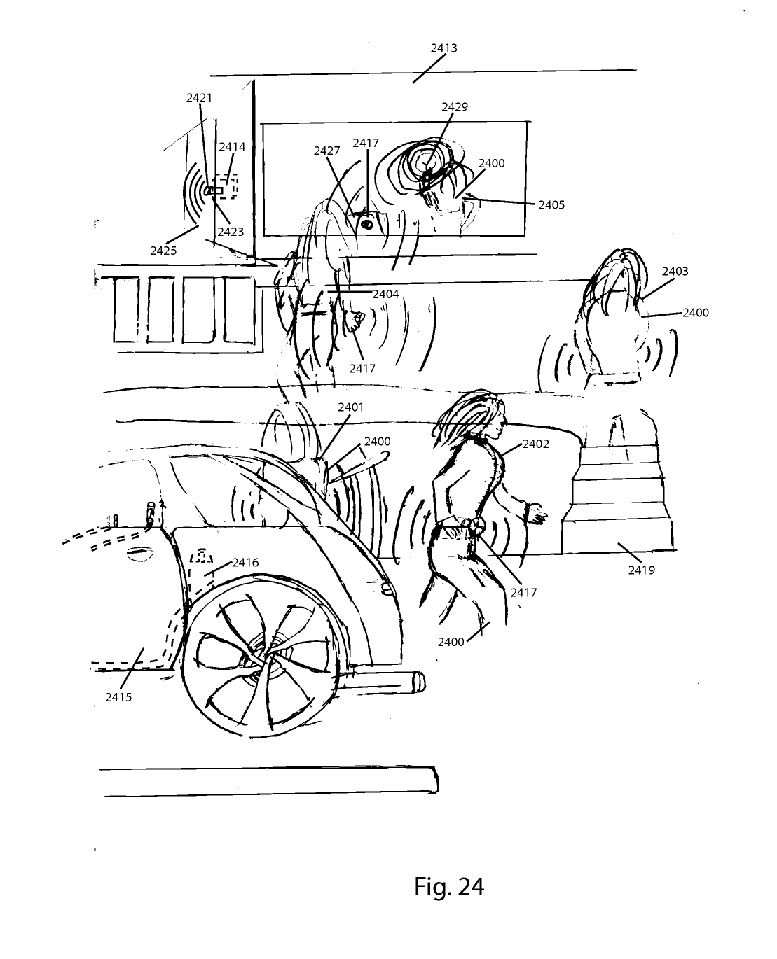

For example, and with particular emphasis on the aspects discussed below, in connection with FIGS. 24-39, the system may carry out any aspects of the present invention as necessary with associated hardware and using specialized software, including, but not limited to, application window presentation user interface aspects that may present a user with a software GUI for selecting properties, changing permissions for user and other person's entry, creating and changing settings for granting access to a property and locking and unlocking locks, generating alerts and data gathering reports for users and/or emergency personnel and generally carrying out any control system steps set forth with reference to those figures. As another example, with reference to FIGS. 1, 13, 14 and 20, such hardware and software may, with or without the presentation of options to a user for selection on a conventional display, carry out any control aspect of the invention as necessary and proper, such as, but not limited to interpreting, implementing and responding to locking and unlocking command signals GUI entries, attempted tampering, authentication challenges (and failures thereof) by locking and unlocking a door, sequestering a key, sensing and recording data, disabling the system due to perceived hacking, sending alerts, and other user interface and processing aspects that may be used in the art, such as physics engines, physical modeling, detection, internet or other network protocols and encryption, image-creation, DNA and fingerprint or other biometric recording and remote or local (such as wired or physical interface) control (and related software).

The processor 2307 is capable of processing instructions stored in memory devices 2303 and/or 2305 (and/or ROM or RAM), and may communicate with any of these, and/or any other connected component, via system buses 2375. Input/output device 2301 is capable of input/output operations for the system, and may include/communicate with any number of input and/or output hardware, such as a computer mouse, keyboard, entry pad, actuable display, networked or connected second computer, other GUI aspects, camera(s) or scanner(s), sensor(s), sensor/motor(s), range-finders, GPS systems, receiever(s), transmitter(s), transceiver(s), transflecting transceivers (“transflecters”), antennas, electromagnetic actuator(s), mixing board, reel-to-reel tape recorder, external hard disk recorder (solid state or rotary), additional hardware controls and actuators, light sources, speakers, additional video and/or sound editing system or gear, filters, computer display screen or touch screen. It is to be understood that the input and output of the system may be in any useable form, including, but not limited to, signals, data, commands/instructions and output for presentation and manipulation by a user in a GUI. Such a GUI hardware unit and other input/output devices could implement a user interface created by machine-readable means, such as software, permitting the user to carry out any of the user settings, commands and input/output discussed above, and elsewhere in this application.

2301, 2303, 2305, 2307, 2319, 2321 and 2323 are connected and able to communicate communications, transmissions and instructions via system busses 2375. Storage media and/or hard disk recorder and/or cloud storage port or connection device 2305 is capable of providing mass storage for the system, and may be a computer-readable medium, may be a connected mass storage device (e.g., flash drive or other drive connected to a U.S.B. port or Wi-Fi) may use back-end (with or without middle-ware) or cloud storage over a network (e.g., the internet) as either a memory backup for an internal mass storage device or as a primary memory storage means, or may simply be an internal mass storage device, such as a computer hard drive or optical drive.

Generally speaking, the system may be implemented as a client/server arrangement, where features of the invention are performed on a remote server, networked to the client and made a client and server by software on both the client computer and server computer. Input and output devices may deliver their input and receive output by any known means of communicating and/or transmitting communications, signals, commands and/or data input/output, including, but not limited to, input through the devices illustrated in examples shown as 2317, such as 2309, 2311, 2313, 2315, 2376 and 2377 and any other devices, hardware or other input/output generating and receiving aspects. Any phenomenon that may be sensed may be managed, manipulated and distributed and may be taken or converted as input or output through any sensor or carrier known in the art. In addition, directly carried elements (for example a light stream taken by fiber optics from a view of a scene) may be directly managed, manipulated and distributed in whole or in part to enhance output, and whole ambient light or other RF information for an environmental region may be taken by a series of sensors dedicated to angles of detection, or an omnidirectional sensor or series of sensors which record direction as well as the presence of electromagnetic or other radiation. While this example is illustrative, it is understood that any form of electromagnetism, compression wave or other sensory phenomenon may include such sensory directional and 3D locational information, which may also be made possible by multiple locations of sensing, preferably, in a similar, if not identical, time frame. The system may condition, select all or part of, alter and/or generate composites from all or part of such direct or analog image or other sensory transmissions, including physical samples (such as DNA, fingerprints, iris, and other biometric samples or scans) and may combine them with other forms of data, such as image files, dossiers or metadata, if such direct or data encoded sources are used.

While the illustrated system example 2300 may be helpful to understand the implementation of aspects of the invention, it is understood that any form of computer system may be used to implement many control system and other aspects of the invention—for example, a simpler computer system containing just a processor (datapath and control) for executing instructions from a memory or transmission source. The aspects or features set forth may be implemented with, and in any combination of, digital electronic circuitry, hardware, software, firmware, or in analog or direct (such as electromagnetic wave-based, physical wave-based or analog electronic, magnetic or direct transmission, without translation and the attendant degradation, of the medium) systems or circuitry or associational storage and transmission, any of which may be aided with enhancing media from external hardware and software, optionally, by wired or wireless networked connection, such as by LAN, WAN or the many connections forming the internet or local networks. The system can be embodied in a tangibly-stored computer program, as by a machine-readable medium and propagated signal, for execution by a programmable processor. The method steps of the embodiments of the present invention also may be performed by such a programmable processor, executing a program of instructions, operating on input and output, and generating output. A computer program includes instructions for a computer to carry out a particular activity to bring about a particular result, and may be written in any programming language, including compiled and uncompiled, interpreted languages, assembly languages and machine language, and can be deployed in any form, including a complete program, module, component, subroutine, or other suitable routine for a computer program.

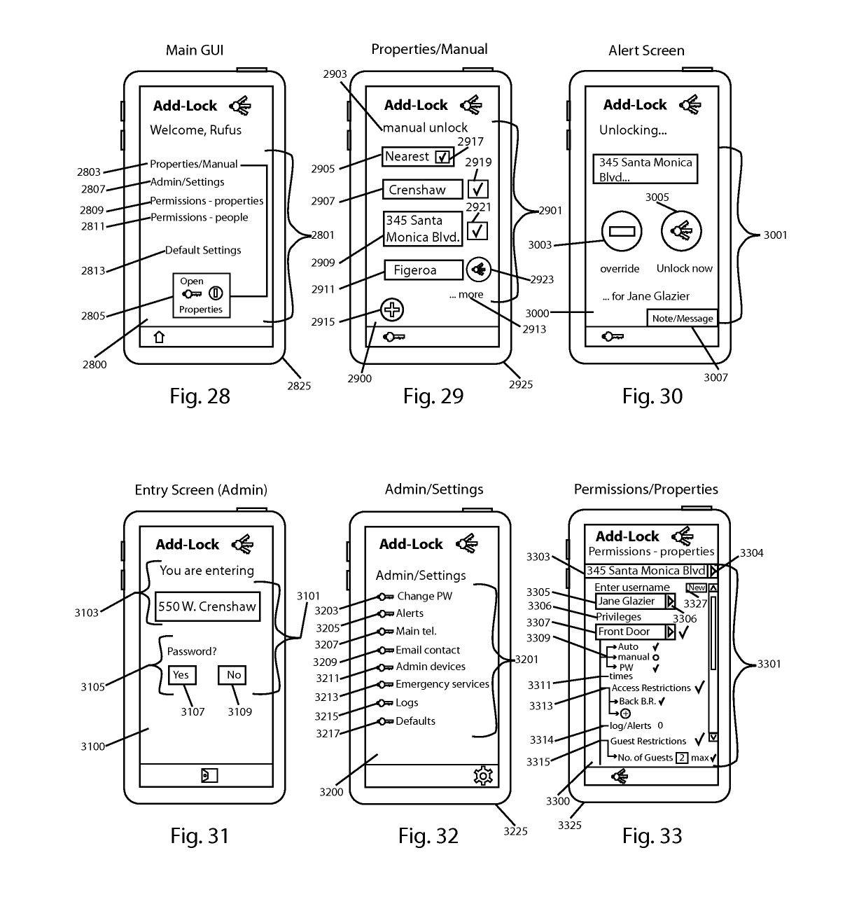

FIG. 24 is an illustration of some exemplary user activities related to an Add-Lock system that includes a control system and wireless user activity monitoring and/or input. The activities illustrated will serve as a platform for discussing other aspects of the invention, including logical steps for a control system, such as a computer hardware and software control system of a nature like that discussed in reference to FIG. 23, above. Examples of such logical steps are set forth below, in reference to FIGS. 25, 26 and 27. In addition, exemplary user interface output(s) and tools (specifically, in a personal digital assistant, smartphone, or portable computer or other computer (“PDA”) screen output format) provided in FIGS. 28-39 illustrate potential output of such a control system.

To frame the discussion, in FIG. 24, an exemplary user 2400 of an Add-Lock system(s) is shown at various stages of activity relevant to the function of the system. First, she is shown near a motor vehicle 2415, having either departed from or arrived near it. That position of the user at that stage is shown as position 2401. Both the motor vehicle 2415 and a house 2413 on a hill above the user have some aspects of an Add-Lock system installed in them (or, depending on the embodiment two or more separate Add-Lock systems). However, although control systems for an Add-Lock system(s) and relevant device(s) are discussed herein, it should also be understood that some control system aspects of the present invention may also, equally, be applied to control systems for more permanently installed doorlock, alert and communication actuation systems. Visible in most depictions of the user 2400 in various positions is a small transceiver, transmitter and/or receiver, or transflecter (elsewhere in this application, “transflecter”) 2417, held or on or about the user 2400 or in or near her personal space. If the user 2400 has just departed from motor vehicle 2415, with the aim of approaching the house 2413 on foot, an Add-Lock control system, such as the control system discussed elsewhere in this application in either the motor vehicle 2415, the house 2413, or both, may react. An exemplary location of an Add-Lock control system is shown for both the motor vehicle (as Add-Lock control system 2416) and the house (as Add-Lock control system 2414). As the user progresses to and from various other positions, also shown as positions 2402, 2403, 2404 and 2405, the Add-Lock control systems 2414 and 2416 will also, further react.

To approach the reaction activity of the Add-Lock control systems 2414 and 2416, we will begin with exemplary control system assessments and reactions if the user 2400 has just parked the motor vehicle 2415 in the position shown, and has then, at position 2401, disembarked from the vehicle, beginning to walk from the vehicle and toward a pathway entrance 2419, with the aim of approaching the house 2413. We will also begin by describing the reaction of the Add-Lock control system of the house 2414, and treat the reaction of the control system for the motor vehicle 2415, separately.

As the user 2400 arrives and disembarks, as shown in position 2401 (or even prior to disembarking, depending on settings for minimum distance for reaction) Add-Lock control system 2414 has been periodically sending wireless signals, preferably focused on or targeting an area surrounding the home 2413 that a user may traverse upon approaching the home with the intent of entering it. For example, a connected or comprised antenna 2421 may be used to send such periodic signals. These periodic exploratory signals may be received by transflecter 2417, which then returns a modified signal to the control unit 2414, which may be reflected or partially reflected from the original signal, but which also contains or is joined with identifying and/or encrypted signal aspects, added or created by selective absorption and/or harmonic or other reactive emanation, for example by vibration(s) which may be unique for every frequency, and/or combination(s) of frequencies or functions or progressions of frequencies received from the control unit, over time. Preferably, these aspects are created in the nature of the reflection from the transflecter 2417, rather than by a separately powered signal, however, or, if powered, is powered by ambient radiation, to avoid the need to change batteries in the transflecter. More specifically, a signal from control system 2414 may be reflected by a coded reflective surface or re-routing channel in transflecter 2417, which removes or modifies some aspect of the signal as it is reflected or otherwise returned, but otherwise retains the energy, power form and/or some other aspect of the original signal from control system 2414 without reconstructing it. Alternatively, vibrations in an aspect(s) of the transflecter, owing to the unique, “signature” characteristics of those aspects and absorb and/or then re-transmit the signal received from the system 2414, lead to suppression, amplification and other alterations of the signal, before reflected re-transmission of the signal, back to system 2414. As the control system receives these reflected wireless transmissions, it may then determine, based on the time of receipt and the nature of its encoding and/or strength as reflected from the transflecter, the distance of the transflecter (and, therefore, the associated user) from the control system 2414 and/or associated lock 2423, actuable by the Add-Lock control system 2414, as well as the transflecter/user identity and authentication. Specifically, that lock is a doorlock to the front door 2425 of the house. However, as will be discussed in greater detail below, any number of alternate or additional lock location(s) may also or alternatively be controlled by one networked Add-Lock system.

At this point, we will turn briefly to the figure describing the steps taken by control system 2414 at this stage.

FIG. 25 is an exemplary process flow diagram of exemplary steps 2500 that may be taken by a system, such as (but not limited to) a hardware and software control system of the nature discussed, for example, with reference to FIGS. 1, 20, 23 and 24, implementing aspects of the present invention. Beginning in step 2501, the system first determines, for example via wired or wireless connections to lock sensors, whether the lock controlled by the Add-Lock system is presently in a locked state, for example, securing a door from unwanted intrusion into a home. If the system determines that the system is not in a locked state, it proceeds to step 2515, which will be discussed below. If, however, the system determines that that lock is so locked, it proceeds to step 2503, in which it sends a brief wireless signal, for example, from a networked or connected antenna comprised in the Add-Lock system. Preferably, that signal may be encoded and/or modulated to cause specific reflections or other reactions in response by transcievers, receivers and systems for transmission response, or transflecters which have been cryptographically tuned or otherwise cryptographically to respond to such a signal with a transflected, further encoded or identifying signal (“transflected signal”), of a nature discussed elsewhere in this application, such as in reference to FIG. 24, above. Also preferably, the nature of the wireless signal issued from the control system at this step is such that it is less frequent, in less frequent bursts of grouped transmissions, briefer, or at a lower power (“Long Periodic Pulse”) than other transmissions, sent at other times by the system. As discussed above in reference to FIG. 24, this wireless signal, when issued from the control system and transflected back by a transflecter, and then received again by the system (for example, by a receiving antenna comprised in the system) enables the system to determine the distance of the transflecter, approximate location or location (if multiple antennas are used) and even the speed at which the transflecter is approaching the system and/or an associated controlled lock, as well as its identity/authentication. The acceleration may be determined by the Doppler effect on the transflected signal received by the system, or by changed distances between different pulses, parts or burst sections of the signal, upon transflection and reception back at the control system. Proceeding to step 2505, the system next determines whether such a transflected signal was issued within a minimum perimeter distance (which may be variably set by the user and/or system) by an authorized/authenticated transflecter/user, based on encryption aspects (if any) that have been added to the transflected signal, and based on programmed settings by a user with administrative privileges, who authorizes transflecters and their users (exemplary GUI system commands for which are discussed in greater detail, below). If an authenticated, authorized user is within that minimum distance, the system proceeds to step 2507, in which it sends a subsequent pulse, for certain user status assessment purposes. If the received signal fails authentication, however, or if the transflected signal emanates from a transflecter that is too far away (outside of a minimum distance, which may be variably set by the user and/or system) the system returns to the starting position. (In the context of the user scenario set forth in FIG. 24, user 2400 may have entered that area by parking nearby the house 2413, as pictured, or by disembarking from her car and walking near to the house, as shown in position 2401). If such a subsequent pulse is sent in step 2507, that pulse may be more rapidly delivered than a gap created between long periodic pulses, and delivered across a range of time periods which, when transflected by the same transflecter, and in conjunction with the transflected pulse that passed the authentication challenge, supplies information received by the system from which the system may determine the direction of movement of a user with respect to the system and/or associated lock, which assessment the system carries out in step 2509. If the transflecter and associated user are actually moving away from the system and associated lock(s), the system then returns to the starting position. (For example, returning briefly to the context of FIG. 24, if the user 2400, instead of approaching the house 2413, moves further away from the house at the time of the subsequent pulse arriving at the transflecter, that may occur.) If, however, the system determines in step 2509 that the authenticated transflecter is moving closer to the system, the system continues to step 2511, in which it sends another encoded and/or modulated wireless signal, the nature of which is such that it is more frequent, in more frequent bursts of grouped transmissions, longer in duration, or at a higher power (“Short Periodic Pulse”) than other transmissions, sent at other times by the system, such as the Long Periodic Pulse and its rates, discussed above. In essence, the system has now determined that heightened energy expenditure for more accurate and timely reactions is now justified, due to the potentially nearing user, in step 2511. As a result, more rapid transflection signals (a.k.a., “feedback”) is also returned to the system, heightening the accuracy and/or currency of its assessment in some further steps.

In step 2513, the system uses the more frequent and powerful transflected Short Periodic Pulse(s) to determine whether the transflecter and associated user have grown even closer to system and/or associated lock, to the point where such a transflecter and user have come within a minimum area or distance from the lock and/or system to cause the system to unlock the door. Such a distance may be variably set by the user, and may vary based on the assessed speed or speed of approach of the user to open the door in time for his/her arrival. As indicated by the figure, if the user and transflecter have not breached the minimum distance after a certain number of Short Periodic Pulse instances (which is shown as an exemplary X times, in the figure, but may be any number of attempts which may be variably set by the user and/or system, or subject to other functions), the system returns to the starting position. If, conversely, the user has come within the minimum unlocking zone, the system unlocks the door, in step 2515.

Preferably, the frequency of even the Long Periodic Pulse is sufficiently frequent such that, even if (as in the instance of FIG. 24) a user 2400 and transflecter 2417 briefly move further away from the system and associated lock (for example, due to position 2402 on the way to the path entry 2419 being more distant than position 2401) even an average to fast user will be detected by the system in time to unlock the door just prior to his or her arrival. To aid in this fine tuning, the system may, alternatively, increase frequency and strength of pulses in more complex intervals, or according to a graduated function. Also in reference again to FIG. 24, the user may have reached a minimum unlocking zone by the time she reaches position 2404, for example, within 2 meters of the door, traveling at 0.5 meters per second. As another example, she might reach that zone by 4 meters, traveling at 1 meter per second, assuming the same assessed vectors. Acceleration assessment, and arrival models, may also be used, in conjunction with velocity models, to determine the user's probable arrival and necessary unlocking time, given the needs of the system to perform that unlocking.

At this point, a user may successfully enter the house, if properly permitted by the system and any administrator who has set the system permissions and other parameters. The system then shifts modes in step 2517 to again emit a longer periodic wireless signal pulse which may, at least in part, be directed inward to assess the user's at-home status and activity. The system may then identify the transflecter as within the home, and, based on its unique identification characteristics (by tracking or unique transflection coding, discussed above, for the user's authentication, or other coding) determine whether to take further action. For example, in step 2519, the system may so identify the transflecter by a unique tracking code specific to that transflecter, such as “TF1.” Again using transflection, the Doppler affect or other speed, acceleration and position determination methods for signals transflected from TF1, the system may determine whether TF1 remains in the permitted home space (which may be variably set and defined by a user, such as an administrator, and/or system to tailor it to permitted zones or approximations of the house/property characteristics). If the user/TF1 is no longer in the home space, the system may send a subsequent signal, signals or patterns thereof to assess any of several user behaviors, and whether those behavior(s) indicate a likelihood of intent to leave the home, or actual leaving the home. For example, multiple transflecters may be placed on objects relevant to the intent to leave, or a separate item (such as a smartphone/PDA) may emit its own signals to the system. For example, if traveling-relevant items are brought into closer proximity by the user (“coupled” transflecters or items), and, in particular, with the user this behavior may indicate such an intent to leave.

For example, again in the context of the activity FIG. 24, user 2400 is present in the home at position 2405, and her transflecter 2417 (TF1) has been placed on a table, 2427, somewhat away from the user and a smartphone 2429, closer to and held by the user, which itself either transflects signals directed from the system or emits its own signals received by the system 2414. If the user suddenly decides to leave the house, she may then pick up her transflecter or, conversely, may pick up the phone or another important travel item equipped with a transflecter or transmitter identified by the system as relevant, when coupled, with intent to leave (which items may be variably set by the user, admin. and/or system), as determined in step 2521. As another example, a user may variably stick transflecter(s) onto a pair of glasses or his or her purse or wallet, and set the system to assume she intends to depart, or alert her if only some of those critical items are in hand, as in step 2523. Such alerts can then be sent by the system, for example, on a smartphone application GUI, or by a speaker built into the system, to remind the user to retrieve those items, in addition to the system taking further steps to secure the home. In any event, if the user has left the home space, and has coupled the departure relevant items with her, the system may then proceed to step 2525, in which it sends a Short Period Pulse to more accurately and currently assess the user's behavior. As indicated in the figure, such pulses may be sent in several instances, each time assessing whether the user has departed a wider zone, which may be variably set by the user and/or system, indicating that he or she has departed from the premises, curtilage or some other distance beyond the home, from which she may be determined to have “left” in step 2527. In that instance, the system then proceeds to step 2529, locks the associated door lock(s) and returns to the starting position. If not, the system terminates repetition of the Short Period Pulse after a certain number of times (which may be variably set by the user and/or system), and returns to step 2519. If, at step 2519, the system determined that the user remained within the home space, but collected departure-relevant items in a step 2531, it may also proceed to step 2525, to better assess user behavior and intent to depart.

The user behavior tracking methods discussed above, related to coupled items and other characteristic behavior of one who is likely to depart the home, are illustrative only, and a wide variety of additional behaviors, such as object recognition of objects associated with leaving, and user actions associated with leaving, may instead, or in addition, be used. As another example, user behavior indicating a deliberate pause at or near a door may also indicate an intent to enter it, requesting permission or unlocking actuation from the system, which may comply if the user is properly authenticated, in some embodiments.

Returning, briefly, to FIG. 24, we next consider user behavior relevant to the activity of Add-Lock control system 2416, for an exemplary Add-Lock system governing a motor vehicle, 2415. We will first consider the effect(s) of the user disembarking from motor vehicle 2415, followed by the effect(s) of the user returning to the motor vehicle, and other relevant effects.

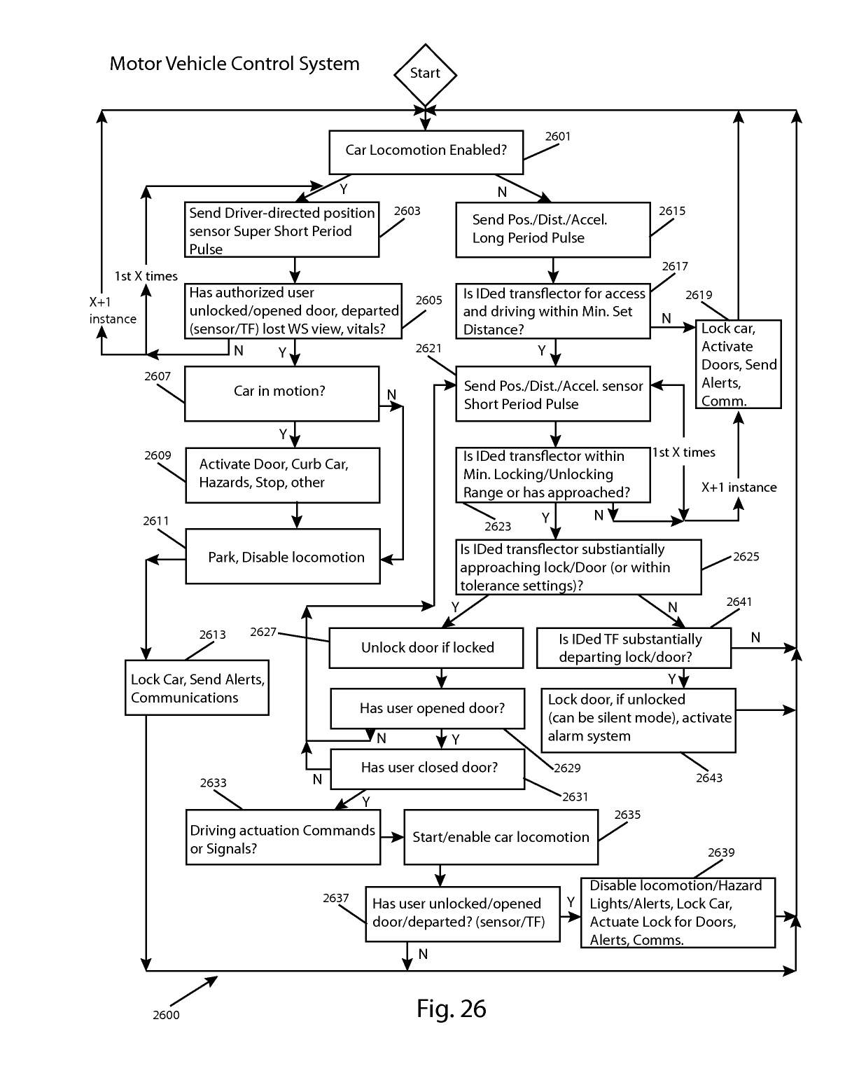

FIG. 26 is another exemplary process flow diagram of exemplary steps 2600 that may be taken by a system, such as (but not limited to) a hardware and software control system of the nature discussed with reference to FIGS. 1, 20, 23 and 24, implementing aspects of the present invention. In particular, the exemplary steps may be undertaken by the control system 2416 associated with and governing an Add-Lock system at least partially installed in, or able to affect, certain operations of the motor vehicle and/or the remainder of the Add-Lock system.

Beginning in step 2601, the system first determines if the motor vehicle (previously shown in FIG. 24 as 2415) presently has its engine running or, as in the case of an electric or hybrid-powered vehicle, is otherwise currently enabled for locomotion by Driving Actuation Commands or Signals, such as, but not limited to, the pressing of a throttle or other accelerator pedal and/or other GUI aspect(s) for driving the motor vehicle—in other words, whether the motor vehicle is “Locomotion Enabled.” This, as in all other motor vehicle and/or Add-Lock condition and activity detection activities, may be determined with the aid of sensors, sensor/actuators, or deduction based on signals relevant to other system activity. If the motor vehicle is Locomotion Enabled, the system proceeds to step 2603, in which it sends a Super-Short Period Pulse wireless signal, which, as in the case of other pulses of wireless signals discussed above, may be transflected back from an authenticating user-location-indicating beacon/transflecter. Again, by the nature, timing and coding of the transflected signal received back by the system, the system may determine the position, movement, and other relevant factors affecting an authorized driver. For example, in step 2605, the system may determine, among other things, whether a transflected wireless signal from such an authenticated transflecter indicates that an authorized user (e.g., driver) has departed the vehicle. Other types of information that may be assessed at this stage include whether a motor vehicle door has been opened, or left ajar, driver's vital signs or indications of consciousness (such as the user losing view out the windshield, “WV”), among other possible driving safety-affecting live, operation-related data. If the driver or other users have not departed the vehicle, and doors have not been opened, and other safety-threatening activities have not occurred for a locomotion-enabled vehicle, the system may return to issue further short or Super-Short Period Pulses or, after a certain number of cycles, return to the starting position. If doors are open, or the transflected signal(s) indicates that a user has departed the vehicle (or, in addition or as an alternative, that a driver/user has departed from the driver's seat), the system proceeds to step 2607, in which it determines if the motor vehicle is presently in motion. If so, the system takes a series of safety-oriented measures in step 2609, such as slowing the motor vehicle, easing the motor vehicle onto a shoulder, curbing the motor vehicle, activating hazard or other lights, stopping the motor vehicle, actuating an open door to close it (if a door is ajar). In the instance of a motor vehicle that may be navigated by artificial intelligence, the system may, alternatively, under some circumstances, take over navigation of the vehicle and/or drive the vehicle to a selected destination—for example, if a driver has merely left the driver's seat, and not exited the vehicle entirely. The system may then proceed to step 2611, in which it may take further steps (at least some of which also may be taken if the car is not in motion, as determined in step 2609). The system may park the motor vehicle (especially if it is determined to be in an inappropriate area, if stopped) and disable locomotion. Further, in step 2613, the system may take additional security-oriented measures, such as locking the motor vehicle doors, and sending alert communications to user(s) or sending emergency notifications, for example, to emergency personnel to indicate an incident requiring their attention, if applicable. The system may then return to the starting position for further assessments and action(s).

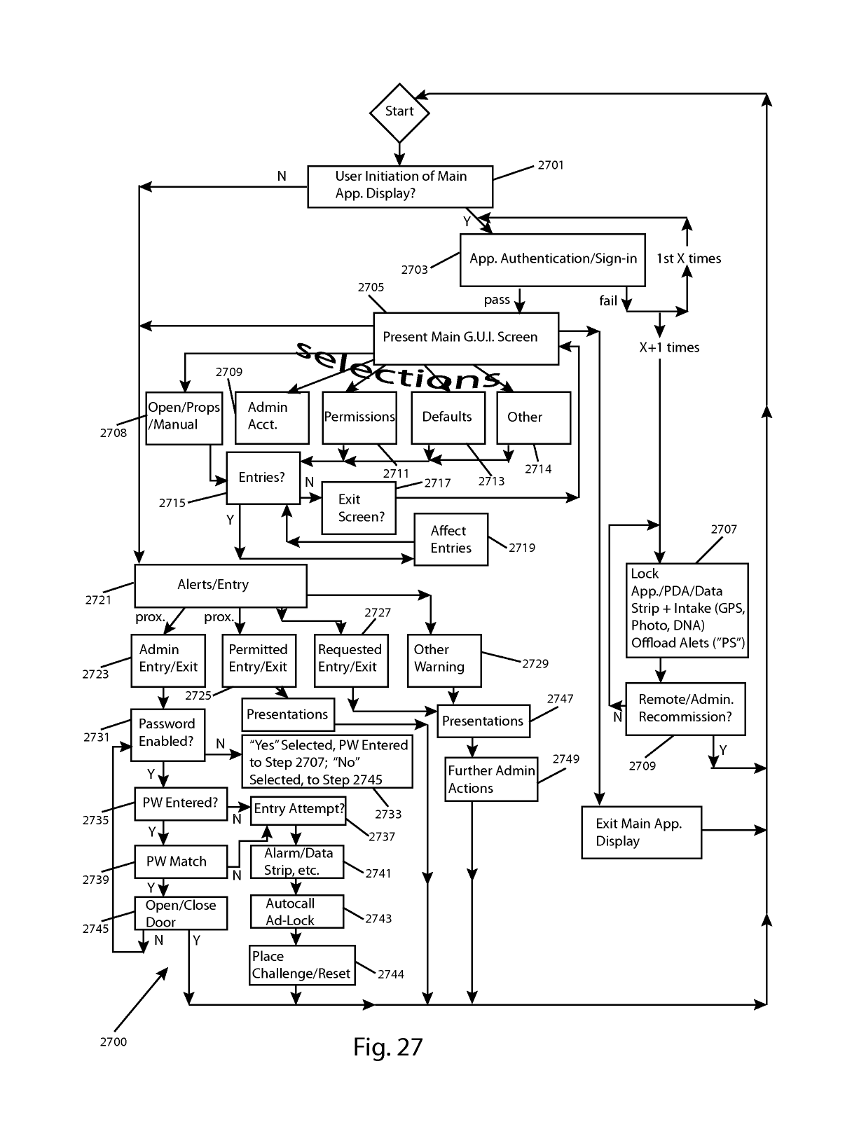

If, returning to step 2601, the system instead determines that the motor vehicle is not running or otherwise enabled for locomotion, the system proceeds to step 2615, in which it sends a Long Period Pulse wireless signal, which, as in the case of other pulses of wireless signals discussed above, may be transflected back from an authenticating user-location-indicating beacon/transflecter. Because the motor vehicle is not yet running, the system thus exerts less energy to probing signals to locate a user and/or driver transflecter (which, as discussed above, may include transmitters or transmitters/recievers), owing to the decreased danger in maintaining the most current or accurate user assessment data. The system then proceeds, in step 2617, to determine whether transflected signals from an authenticated, identified transflecter indicate that a user is present within a minimum distance or area, which may be variably set by a user and/or the system, indicating the need for potential further actuation action by the system. If a user is not within that distance, the system may proceed, in step 2619, to secure the car/motor vehicle, if it is not already secured, for example, by locking the doors to the motor vehicle. If the system has newly locked the doors and/or taken other new securing measures, in step 2619, the system may also send alerts or other communications relevant to that activity—for example, by issuing notifications on a GUI, such as a GUI presented on a PDA screen by a PDA application, examples of which are discussed in greater detail below. The system may then return to the starting position. If, however, the system determines in step 2617 that a user's transflecter is present within the minimum distance, it may proceed to step 2621, and send a Short Period Pulse signal, to begin tracking user activity more closely. In step 2623, the system may determine, based on properly authenticated, returned, transflected signals (determined, for example, by system settings, which may be variable by an administrator), whether an authorized user is present within an even smaller area than the minimum distance set forth above, termed a “Minimum Locking/Unlocking Range,” from the motor vehicle, Add-Lock system, and/or any part of either and/or related item, as variably selectable by the user and/or system. If not, the system may return to step 2621 to repeat the Short Period Pulse for a certain number of variably-set instances, or a variable amount of time, before returning to the starting position and/or locking the vehicle, as necessary. If the transflecter is within minimum unlocking range, however, the system may proceed, in step 2625, to determine whether the user is substantially approaching the Add-Lock system (or an associated door and doorlock), which substantial approach can be established by minimum time spent traveling at least partially in that direction, or by the amount traveled in that direction, or both, among other measures. If the user/transflecter(s) is substantially approaching the system, vehicle or part(s) thereof, the system may proceed, in step 2627, to unlock at least part of the motor vehicle for access by the user. The system may also, for example, if the user is identified as a driver, engage or actuate other aspects of the vehicle to ready it for action, for example, by starting the vehicle's engine, if applicable. Also, although not set forth in the figure, the system may take other security and safety actions, such as engaging safety restraint devices, and closing the vehicle doors, if they have been determined to be opened, as in step 2629, or completing closure of such doors, if the user has cleared a safe area for such closure. The system may also lock the door(s) after users, and otherwise prevent other users from entering the vehicle after the identified, authenticated user, and issue alerts (which may be manually overridden by the user) regarding such events. If the system has unlocked the vehicle for a user, but the user has not opened the vehicle or entered it, the system may return to sending Short Period assessment Pulses. If, however, the system determines, in step 2629, that the user has entered or at least opened the vehicle door, the system may proceed to determine, in step 2631, whether the user has proceeded to close the door behind him or herself. If not, the system may again repeat Short Period Pulses to track the user actions closely. If so, however, the system may proceed, in step 2633, to determine whether the user is an authorized driver and, if so, whether he or she has engaged in driving-actuation commands, signals or gestures, or those relevant to the intent to begin driving shortly. If such commands, signals and/or gestures have occurred, as sensed by the system, the system may proceed, in step 2635, to start the vehicle/enable its locomotion by a driving system and/or user. Then, while under such operation, the system may (as in steps 2603 et seq.) take security and safety-related actions if endangering conditions have occurred, such as the door being unlocked or opened or a driver or user is attempting to depart the vehicle during locomotion, as stated in step 2637, or if the driver's weight or other biometric data do not substantially match records, and disabling further locomotion, activating hazard lights, locking the vehicle from operation or locking its doors, and issuing alerts or communications, as discussed earlier, in step 2639. If no such endangering conditions have occurred, the system may continue to enable the vehicle for locomotion and return to the starting position. If, back at step 2625, the system does not determine that the user is substantially approaching the system or vehicle, or part(s) thereof, it may proceed to determine whether the user/transflecter has substantially departed the vehicle and/or system and/or part thereof, in step 2641 and, if so, secure the vehicle, for example by locking its doors and/or activating a car alarm subsystem in step 2643. To avoid bothering the user and/or alerting others in the vicinity, the locking/unlocking steps, such as in step 2643, may be carried out in a “silent mode” that is undetectable, selectively detectable, or less detectable than ordinary car locking activity. However, any actuation activity and condition may be broadcast to users and/or administrative users, for example through a PDA GUI, such as the GUIs discussed in greater detail, below. The management of such a GUI may be handled by another flow of system/method steps, set forth in FIG. 27, as discussed immediately below.

FIG. 27 is another exemplary process flow diagram of exemplary steps 2700 that may be taken by a system, such as (but not limited to) a hardware and software control system of the nature discussed, for example, with reference to FIGS. 1, 20, 23 and 24, implementing aspects of the present invention. In particular, steps of a similar nature may be undertaken by an Add-Lock system and, in particular, a control system, such as that depicted in FIG. 23, or as 2414 or 2416 or as otherwise associated with and governing an Add-Lock system at least partially installed in, or able to affect, certain operations of a number of lockable real estate and/or other properties. Particular emphasis will be paid, in FIG. 27, to the system's creation and management of user controls presented and actuable in a GUI, in the management of aspects of such an Add-Lock system managing such real estate or other properties. To illustrate, we will also refer to exemplary GUI presentations on an exemplary PDA viewing screen in FIGS. 28-39, throughout the discussion.

The Add-Lock control system begins by proceeding to step 2701, in which the system determines whether a user has initiated the display of a Main or Home screen of an exemplary PDA software and hardware application, onto the screen of a PDA, for example, by user behavior or user/transflecter location detection by the PDA, or the double-clicking or tapping of an access icon displayed by a PDA operating system (not pictured) being programmed to cause the initiation of the application. Such a Main presentation screen is illustrated as FIG. 28, and includes several exemplary sub-features, which will be discussed herein. But before allowing the presentation of the Main GUI screen, the system may first prompt the user with an authentication routine (such as a username and/or password challenge, or biometric sample challenge, or unique or coded physical sample challenge requiring the user to scan such samples upon request by the system) in step 2703 and the system may only proceed to present the main GUI screen, in step 2705 if the user has passed such an authentication challenge. If the user has failed the authentication challenge, the system may provide the user with a limited number of repeated opportunities for attempts—optionally, with prompts for an option to reset authentication data via a verified separate process, and/or with Turing or other tests—after which the system may lock out further attempts, and/or the PDA, user's account and/or other system aspects from further attempts and/or use, in step 2707. Also optionally, if a portable system component, such as a PDA, is being used by the user and the maximum amount of failed attempts has been exceeded, in some embodiments, the system may off-load data or strip data and user/environment samples from the PDA, to protect it from the PDA and its data from unauthorized access and/or aid in investigation and/or prosecution by authorities. For example, as indicated in step 2707, the system may cause the PDA to take GPS or other activity-/location-indicating data, photographs of the user, audio samples, or DNA or other biometric samples from the user (e.g., strip skin cells in an outer shell of the PDA and encapsulate them in tamper-proof, fireproof microstructures, and analyze those samples and collect data, and/or drop the samples locally, take signature galvanic or EKG readings) and may upload those data via a wireless network, which activity may be in addition to disabling the PDA. After such locking and/or stripping of the PDA or other remote terminal or device used to control the system, and/or after data sampling and export, an authenticated administrator user and/or other system reset aspect may still be able, remotely from another location and device, to recommission the PDA/device subject to that stripping, sampling and/or export step and/or reinstate the user's account, in subsequent step 2709, after which the system may return to the starting position. Such recommissioning may involve restoring data to the PDA/device and operating conditions, to an earlier state. If, however, no such recommissioning or reinstatement has taken place, the PDA and/or user account may remain in that condition.

Once reached, the main GUI screen of FIG. 28 (triggered in step 2705) presents an administrator/user with a number of actionable user interface items. By activating some of these items in an actionable area 2801 of the screen 2800 (which may be a touch screen of a PDA 2825), a user may summon the presentation of other GUI screens and/or cause the system to carry out various administrator/user actions and steps. Among the items that may be so activated by a user/administrator (for example, by double-clicking on or tapping on the item on the screen with a finger or stylus, in the instance of a touch screen) are several menu items, which may be hyperlinks or other types of user interface links, such as, but not limited to, a button. These menu items include item 2803, a selectable link or button titled “Properties/Manual,” which, if activated, causes the system to present a separate GUI screen of that title (shown in FIG. 29), in step 2708. Moving briefly down to the bottom of the GUI screen shown in FIG. 28, a button with a key-and-lock-shaped icon and stating “Open Properties,” appears, labeled item 2805. By activating that item, the user/administrator would again proceed to the GUI titled “Properties/Manual” (FIG. 29), and the item is therefore visibly linked on the “Main GUI” screen with Properties/Manual item 2803, to indicate a common, linked or similar pathway. However, by activating item 2805, certain settings or selections within the Properties/Manual GUI may be preconfigured or actuated upon, or even before, the user/administrator arrives, to hasten unlocking actuation activity by the system. For example, as pictured in FIG. 29, a preconfiguration item 2903 may indicate that such preconfiguration has taken place, specifically, for the purpose of making several real estate properties, listed by title below it as items 2905, 2907, 2909 and 2911, immediately lockable, securable, and/or unlockable by a single touch, by further items beside each of them, shown as items 2917, 2919, 2921 and 2923 (“Lock/Unlock Action Items”). The Lock/Unlock Action Items each appear in one of at least two varieties: (a) a check-box icon, indicating that the property beside it is presently unlocked or otherwise unsecured for guests, but may be secured by the system upon activating that icon or item; and (b) a tri-key icon, indicating to the user/administrator that he or she would have to activate that icon or item to unlock or otherwise unsecure the property. Upon such activation, the system may, depending upon user and system settings, immediately so lock/unlock or close/open doors and activate/deactivate security alarms, among other possibilities for securing/unsecuring the properties. If, however, the user activates the “Properties/Manual” item 2803, instead of button 2805, to reach the GUI shown as FIG. 29, the system may not include item 2903 and may, instead, simply present a (perhaps larger) list of property items 2905-2911, with the resulting increased available space. In any event, by activating those property items, the user/administrator may then be presented with a “Permissions/Properties” screen, for example, as shown in FIG. 33, for the configuration of various settings related to each such real estate property, the security of which may be managed by the control system and the Add-Lock system generally. If all such available, managed real estate properties cannot simultaneously fit onto the GUI screen shown in FIG. 29, an actionable item 2913 is provided to access an expanded list of actionable items for all such properties. Furthermore, a user/administrator may add additional properties to be managed by the control system and Add-Lock system with another actionable item 2915, which would present a GUI screen for the adding, labeling and otherwise configuring of such additional properties, such as, but not limited to, such actions as may take place with the screen shown as FIG. 33.

From the Main GUI screen set forth in FIG. 28, a user may activate a number of additional menu items, in addition to item 2803, which cover some additional major functions of the exemplary control system for a user/administrator. Each of those additional menu items also lead to further specialized GUI screens, with further options for controlling aspects of the control system, enabling a user to make entries with any of those GUI screens, as indicated in step 2715 effected by the system in step 2719, and/or exit the specialized GUI screen, and return to the Main GUI screen, in step 2717.

For example, by activating item 2807, titled “Admin/Settings,” a user/administrator may summon the GUI screen 3200 shown in FIG. 32, which may present the user/administrator with a wide variety of actionable items within an actionable area 3201 for reviewing and altering account information and settings, such as, but not limited to: (a) setting and changing the username and password for authentication in step 2703 via item 3203, (b) setting/reviewing/changing the nature, timing or triggers for alerts sent by the control system upon carrying out control actions and sensing activity via item 3205, (c) setting/reviewing/changing auxiliary contact and account resetting information that allows the system to verify account access and otherwise contact the administrator/user outside of the GUI via items 3207 and 3209, (d) setting/reviewing/changing PDAs, transflecters and other devices that are authorized to access or cause the actuation of control system administrative aspects, and what aspects they may be allowed to access/control, via item 3211, (e) setting up, configuring, or verifying access to emergency services, such as third-party security/safety services that will manage critical notices from the system, verify critical lock and other security or safety breaches, and receive and manage alarms and relevant data, and, if appropriate, forward or send external alerts to emergency personnel, such as the local police or fire department, via item 3213, (f) view access logs, which may list the timing and nature of system activity, such as the locking and unlocking of real estate properties, the sending of messages or other data (or data access) to various users (including automatic sending) and the identity of those transflecters/user granted access to what properties, at what time, via step 3215, which may be viewed or downloaded, for example, in a spreadsheet format, and (g) reviewing, altering and configuring default settings of the account/Add-Lock control system, for various types of system activities that the user may not wish to specifically set forth for each instance in item 3217—such as, whether to send alerts, messages or other data or data access when users, in general, are granted access via the system, rather than having to set that parameter while adding each and every user to be granted automatic access by the system.

As another example of potential action items for the Main GUI screen, an admin/user may activate 2809 or 2811, which may lead the system to present dedicated GUI screens for reviewing and altering permitted access to properties by users as managed by the control system, and the Add-Lock system generally. By activating the “Permissions/Properties” menu item, the admin/user may be taken to a GUI screen such as that depicted in FIG. 33, presenting the identity of real estate or other properties (which may include virtual properties—such as data files and programs, in which case the system may send such data or create such access, as it might create physical access to properties) managed by the system (as in actionable item 3203), and several sub-options for the management and control of each of those properties, such as actionable items 3305-3315. Several of those actionable items, when activated, may present various sub-items indicating statuses, settings and options. For example, item 3303 may, as pictured, show permissions settings for a single property at a time, the title of which is indicated in a window, but a toggling arrow sub-feature 3304 may permit the admin/user to change the view to present such permissions and settings for another, next, property. Among the options for each property is the ability to view and make alterations for each permitted user, which may be shown in an actionable window 3305 which may include a similar toggling arrow, to review the statuses and make changes for other users. For each such user authorized by the admin/user and system, a series of actionable items below item 3305, and which may be expandable/hideable to make best use of space, are included within an expanded actionable item 3306. For example, the admin/user may dictate whether the user (in this instance, a female, human user named “Jane Glazer”) is permitted entry to the property in question (in this instance, a property identified by its address as “345 Santa Monica Blvd.”) and, if so, which door(s) she may be provided access through by unlocking an associated lock controlled by the system, via expanded sub-item 3307. Among other parameters, an admin/user may dictate what times and durations a user may access the property via item 3311, and restrict the user's access to particular areas of the property via sub-item 3313, beyond which the system will lock out, or issue alerts or alarms concerning, if access by that user occurs. The admin/user is presented with a listing of such restrictions within item 3313, and whether any violations have occurred in rapidly acquired status indicators—namely, check marks to the right-hand side of each restriction. For example, in this instance, a restriction from the “back bedroom” of the property is indicated, and a check mark indicates that no breach of that area has been undertaken by the user subject to the restriction (Jane Glazer). And the admin/user may add additional restrictions, by activating the button with the plus symbol (“+”), indicating the ability to add such additional restrictions, via an associated sub-item for selection and entry of such restrictions (not pictured). Items which have not been selected or that otherwise have a different condition may have another status indicator for relaying that status, as in the “0” appearing next to item 3314, which may indicate whether alerts have been issued for the user's access to the property, and, if activated, may export a log displaying those alerts. An admin/user may temporarily provision/restrict the access of guests, or a number of guests, that come along with the authorized user. For example, if the admin/user is a landlord and wishes to permit a real estate broker (such as Jane Glazer) to so access the property to show it, he may restrict her showing to accompaniment by a number of guests, for example 2 guests, which, if exceeded, may result in restriction of access or issuing alerts/alarms. To monitor the existence of such guests, the system does not necessarily need to detect a transflecter for each of them and can, instead, sense the number of bodies in the vicinity of the door for which access is sought, for example, by thermal imaging sensors. Among other exemplary settings, In addition, the admin/user may add new properties for management, via a GUI screen dedicated to that purpose linked through the button titled “New,” item 3327. However, the settings shown in FIG. 33 are exemplary only of the vast number of access, user and property permissions settings that may be included in such a GUI and in the system.

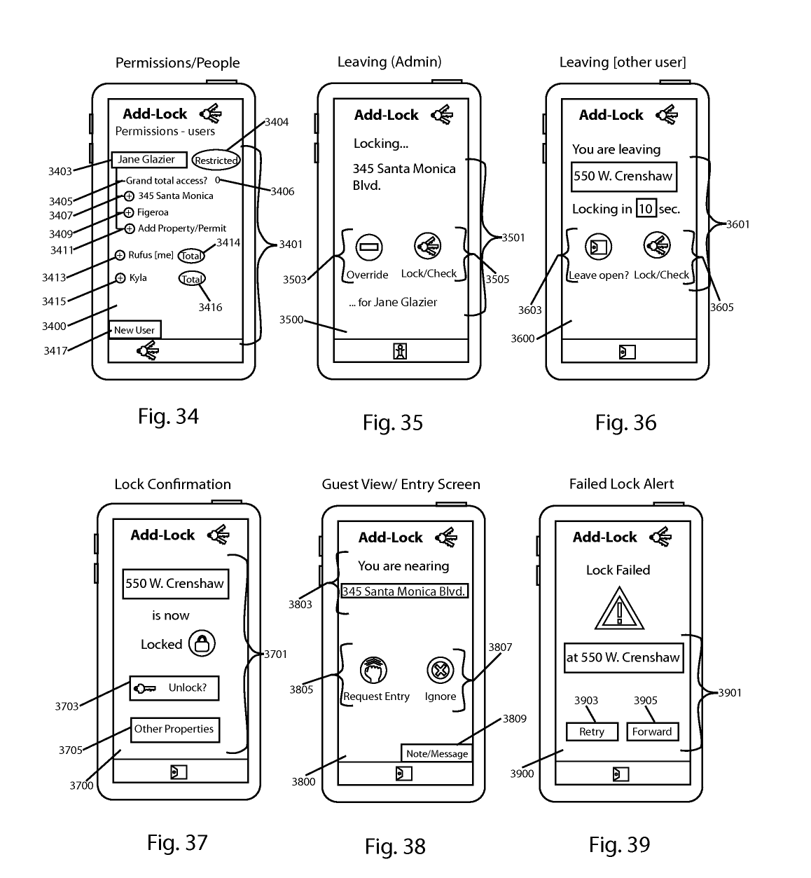

In some instances, it may be preferable for an admin/user to review property permissions in another organizational format. For example, as shown in FIG. 34, a user may instead access via step 2711 a GUI screen for reviewing and altering permissions that lists such permissions by user, rather than by property. This type of alternate format GUI screen may be particularly helpful where, as in the instance of a real estate broker, such as, in these examples, Jane Glazer, or for a close relative, such as, in these examples, the user's daughter with the name “Kyla,” a single user might be granted access to several different properties owned or managed by the admin/user, in these examples, named “Rufus.” As shown in FIG. 34, an expanded actionable item 3403 identifies Jane Glazer as a currently permitted system user, but with limited or “Restricted” access to particular properties managed by the system. That status is indicated by a sub-item 3404, but the admin/user may actuate that sub-item to alter that status, for example, by touching it or gesturing at or concerning it (as maybe detected by system sensors on a local PDA, which may, for example, assess whether living tissue in the shape of a finger is generally pointing at a particular point in the screen comprising the item, and then moving in and then out (a.k.a., “air-tapping”) in that direction substantially enough and for a proper clicking on or double-clicking duration and timing to trigger activation) as with other items. Further actionable sub-items 3405-3409 list the exact restrictions, when optionally expanded by actuating expansion sub-controls (denoted by plus “+” symbols) for each such sub-item, for each property to which the user is granted some permissions. The admin/user may alter any of those restrictions, add to them, or remove them by actuating sub-items (some not pictured) or by changing general settings. For example, by actuating sub-item 3405 or 3406 next to it, (the “0” symbol of 3406 indicating that Total Access is not granted) the admin/user may quickly grant total access to the user, ending all of the restrictions indicated. In that instance, actionable items for that user then may appear with a status indicator, indicating “Total” access, as in the actionable indicator items 3414 and 3416, indicating that the users to which actionable items 3413 and 3415 (next to 3414 and 3416) relate have been provided with such total access. New users may be added and given permissions and restrictions with respect to any property managed by the system, by actuating/activating item 3417, and GUI features triggered by that item (not pictured).

Another exemplary Main GUI actionable item is depicted as item 2813, entitled “Defaults” or “Default Settings”. As with the “Defaults” actionable item shown in FIG. 32, this item, if actuated by the admin/user, may permit reviewing, altering and configuring default settings of the account/Add-Lock control system, for various types of system activities that the user may not wish to specifically set forth for each instance, such as, whether to send alerts, messages, data or data access when users, in general, are granted certain access via the system, rather than having to set that parameter while adding each and every user to be granted automatic access by the system.

The several directly-accessed control system GUI screens discussed above are not exhaustive of the virtually infinitely variable options for presentation, modification, issuing of commands to, and receiving communications, other data or data or other security access to or from, a control system in connection with the aspects of the invention discussed in this application—any such options for which would also fall within the scope of the invention. Rather, they are presented herein for exemplary purposes, to illustrate how such control system aspects may be included.

Even if a user does not directly access GUI screens, as discussed above, the system may nonetheless take several actions, and allow an admin/user or other user to take several actions, affecting the performance of the control system, and the Add-Lock system generally. For example, as discussed elsewhere in this application, a user whose behavior may be tracked by the system (for example, via transflected wireless tracking and authentication signals) may trigger action(s) by the system through her behavior, for example, by nearing certain zones set for such action(s). Some of those actions, as discussed, may include Entry and Departure from properties, in which unlocking or locking, and opening and closing of doors, receiving messages and data access, among other things, being carried out by the system. In those instances, the system may also issue notices, alerts and other communications to an admin/user, as well as to the user granted access or otherwise monitored and/or controlled by the system, and/or prompt the Admin/user for further potential action(s). Examples of those types of actions by a user, admin/user and the system and the related communications and presentations by the system and/or users, may begin with a step 2721, in which such alerts or other communications are initiated for entry or other access to property(ies) controlled by the system. Exemplary steps 2723 and 2725 may be carried out in the event that user behavior proximity sensing activity, such as the examples discussed above, by the system indicates behaviors warranting potential further responsive action by the system. In step 2723, an admin/user may be identified by the system (for example, by transflecters in the manner discussed elsewhere in this application) as nearing and requiring unlocking of a door to a property by the system, for example, within a Minimum Unlocking Zone, as discussed elsewhere in this application. At that point, the admin/user may be presented with a GUI screen alerting him or her that he or she is within that zone that may cause property access actions, and prompting him or her for an authentication routine, such as one including the entry of a password or other challenge (e.g., biometric, or other metric scan, such as a local code held on a device such as a card). An example of such a GUI screen so notifying and prompting and admin/user is provided as FIG. 31. To prevent issues related to unauthorized theft, borrowing or hacking of identifying transflecters and/or PDAs, or other authentication devices, and/or the system, the system may have a setting requiring a password entry as well, but, beyond that, the password status itself may be held secret, which will assist in the identification and investigation of unauthorized access attempts. For example, in addition to a managed property alert item 3103, to inform the admin/user of the zone status, the identity of property subject to potential unlocking and other actuation events by the system, the actionable area 3101 of screen 3100 may include an authentication prompt 3105 that is ambiguous as to the existence of a password or other authentication routine. An admin/user familiar with the system will know whether or not an authentication routine is required, and may make the appropriate selection “yes” (actuable sub-item 3107) or “no” (sub-item 3109). In some embodiments, whether or not the authentication routine is required, the correct selection to complete the routine may be to actuate the “yes” sub-item. If the wrong selection is made (e.g., the “yes” sub-item when no authentication routine is required for the system to continue granting access), at step 2733, the system may nonetheless continue to present an artificial authentication routine and, while the unauthorized user attempts to actuate it, move to step 2707, and gather investigative data and take other steps to secure the property and PDA, as discussed previously. Similarly, if the correct selection of an authentication protocol is made in step 2731, but a required (e.g., password) authentication routine is failed or not completed prior to an attempted entry (in steps 2735, 2737 and 2739) the system may, again proceed to the security steps, such as those set forth in step 2707, or, alternatively (as pictured) may initiate a system and/or associated service phone verification procedure, otherwise grant access in steps 2741, 2743, and 2744, based on the user/administrator having forgotten the authentication routine using the system as just described, or some combination of aspects of all of those steps. However, if the admin/user correctly completes the authentication challenge, or avoids it if not required, the system may proceed to take any of the access providing steps set to be taken by the system or admin/user, as described elsewhere in this application, such as, but not limited to, unlocking and opening doors to permitted areas of the property in advance of arrival, and closing it behind the user, in step 2745.

Proximity or other user-behavior-initiated actions by the system may take place with non-admin users as well, as set forth in step 2725, whose system-relevant behavior is identified in the same way by the system. In such instance, the other user, if using another PDA or other system device capable of such GUI screen controls, may be provided with a specialized screen, an example of which is shown as FIG. 38, to facilitate the user's, and/or an admin/user's, actuation of the system with respect to the property to which the user's behavior relates. For example, if the other user is within a Minimum Unlocking Zone for the property, the system may cause the other user's PDA to present a notice item 3803, indicating that he or she is nearing that property, which is identified by name. The user is then presented with options to hasten the process, or request entry altogether, if their permissions do not allow entry without admin/user assistance. For example, the user may request entry from the admin/user by activating actuable item 3805 or, if not necessary to gain access, minimize or remove the screen 3800 using actuable item 3807, to free up other use of the PDA. In addition, the user may actuate button 3809 to send a message to the admin/user, explaining his or her need or desire to access the property, request access more formally, or for other reasons, using a screen for such message entry (not pictured). The other user may also receive and respond to further replies or other messages from the admin/user using further messaging-oriented GUI screens (not pictured).

As another exemplary possibility, or in conjunction, and admin/user him or herself may be presented with an alert GUI screen upon an other (“Guest”) user entering a Minimum Unlocking Zone, such as that depicted as screen 3000 of FIG. 30. If the settings permit the user entry by proximity behavior, the system may so indicate that it is “unlocking” a door or otherwise carrying out actuation to permit access for the user to the stated property. However, the system may provide a time period for the admin/user to become aware of the alert before unsecuring the property, and may nonetheless present the admin/user with actionable items to hasten the process, such as item 3003, which, if actuated by the admin/user, will prevent the unlocking or other unsecuring action related to the property. Alternatively, the admin/user may actuate item 3005 to immediately cause the system to open or otherwise unsecure the property for the other user's access. In addition, the admin/user may initiate a message or other dialogue with the guest user, by actuating button 3007.

In still other instances, a new user (or attempted user) with no previous permissions with respect to the property, may seek access to a property managed by the system, using the system, as indicated in step 2727. In that instance, the admin/user and other user may each be presented with GUI screens permitting the actions of requested entry, approval or disapproval by the admin/user, and adding (optionally) the new user to the system (not separately pictured). A wide variety of other alerts, warnings, and action screens may also be provided to users, trespassers, admin/users and others whose behavior may involve the system, in similar steps 2729, also followed by steps 2747 and 2749. While not all possibilities are specifically demonstrated, some examples of such screens include the “Lock Confirmation” screen of FIG. 37 (indicating that a locking or other securing actuation of the system has succeeded), the “Failed Lock Alert” screen (indicating that a locking or other securing actuation of the system has been attempted, but failed) of FIG. 39, and the “Leaving” screens, FIGS. 35 and 36, for an admin/user, and other (“guest”) user(s), respectively (indicating that the user is perceived to be leaving, and system actions that will be taken, among other things.

In the instance of the “Leaving” GUI screens, FIGS. 35 and 36, the Admin/user or other (“guest”) users are presented with notifications of securing activity being carried out with respect to a property based on their behavior indicating that they may be leaving the relevant proximity of an Add-Lock system, or engaging in other behavior relevant to the intent to leave—such as coupling and location of tracked transflecters and other items for that purpose, as discussed with reference to FIG. 24, above, among other places. Upon receiving such alert notifications, users may cancel the securing actions of the system, for example, by activating item 3503 or 3603. Alternatively, the user may hasten the locking or other securing process, or check the status of that process, carried out by the system, by activating item 3505 or 3605. Each such activation would summon further GUI aspects (not pictured) enabling such further action and/or notices by the system.

After a property has been secured, or if it has failed to be secured after an attempt to secure it by the system and/or user, the system may alert a user of such statuses in FIGS. 37 and 39, respectively, and provide a user with an item for directing the system to reverse or retry its securing efforts (actionable items 3703 and 3903, respectively) review the status of other properties (item 3705) and/or send an alert concerning securing/failed securing status to others (item 3905), among other possibilities.

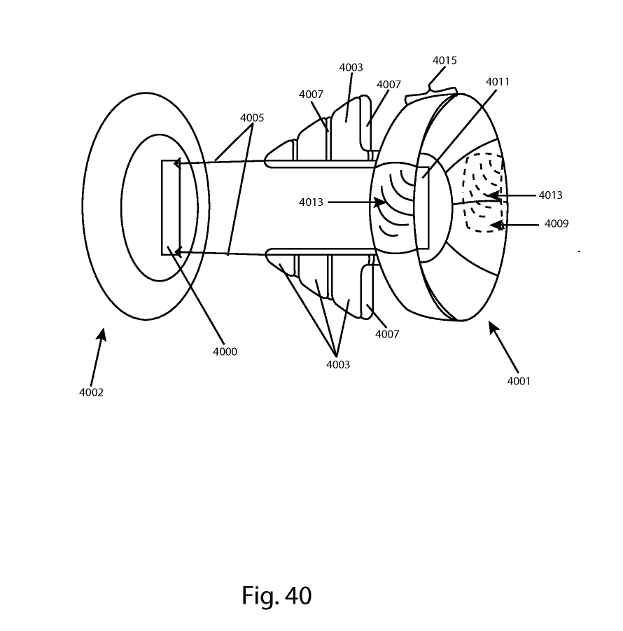

FIG. 40 is a perspective view of a key guidance and key-hole protection system 4001 that may be temporarily, and replaceably, mounted onto a key-hole, such as that pictured as 4000. As with the key guidance and key-hole protection aspects discussed above, with reference to FIGS. 21 and 22, system 4001 serves to intervene between the scratching and scratchable surfaces surrounding the key-hole and of the key, to keep them pristine. However, unlike the aspects discussed with reference to FIGS. 21 and 22, system 4001 is mounted on the key-hole 4000 and door 4002, not a key (not pictured), and need not retract any part or subsection of itself to allow a key to interface with the key-hole 4000 or other part of a lock. However, in other embodiments, some system- or user-actuable moving parts (such as a lockable, actuable key-hole covering flap, not pictured) for variably locking onto and closing the key-hole (for example, to prevent lock-picking) may be included.

System 4001 may comprise semi-flexible, insertable and lockable tab(s), such as those examples shown as 4003 which, as pictured, may be inserted into the lengthwise ends of a key-hole (as shown by insertional direction arrows 4005). In so doing, tabs 4003 may flex inward, toward one another, until passing through key-hole 4000, after which point they again diverge and snap back approximately into their original position. At that point, reverse-resisting walls of tabs 4003, such as those examples shown as 4007, grip the inside walls of the key-hole, and prevent escape of the tabs 4003—mounting system 4001 onto the key-hole and door. The outward-facing surface 4009 of system 4001 is preferably concave and curved to guide inserted keys toward the center, covering the edges of the key-hole, and into a complementary port 4011 that exits into the key-hole. The center is preferably thin enough to avoid substantially interfering with the normal extension of a key into the keyhole, through it. Longitudinal voids or grooves (not pictured) in surface 4009 may also be included to prevent interfering with the distal edges (nearest the key hole) of the key. To aid in withdrawing system 4001, a user may compress the edges 4013 of the cover section 4015 which, owning to the semi-flexible materials and structures in communication with those edges that are also connected to the proximal end of tabs 4003 (nearest the keyhole), tends to drive the tabs together. However, even without so pinching edges 4013 together, preferably, sufficient withdrawing pressure will permit the removal of the system, unless the system is of the alternate type discussed above, for variably locking the keyhole shut to prevent lock-picking and other mischief, in which case the materials used are preferably less flexible, and disengagement of a key-hole closing flap and/or tabs 4003 from the key-hole may require specialized tool(s) or a specialized routine, such as authentication via a control system, for example, in accordance with aspects set forth elsewhere in this application.

I claim:

1. A portable Add-Lock system, comprising a door-locking device capable of mounting fast to a door jamb, door frame, or other associated, fixed structure, regardless of whether the Add-Lock system is presently locked or being locked, and requiring no damage or other permanent alterations to a door, doorframe or other parts of a room to install and/or uninstall.

2. The portable Add-Lock system of claim 1, further comprising a ramped locking piece and/or button that may engage with the swinging side of a hinged door such that, if the door closes from a great enough degree of openness, it encounters a sloped and/or rounded surface on said button, and drives said button downward, passing by said button.

3. The portable Add-Lock system of claim 2, further comprising in which a ramped locking piece and/or button that may engage with the swinging side of a hinged door such that, if the door begins to open from a substantially closed position, it encounters a barbed, flat, or otherwise holding side of said ramped locking piece and/or button, which holds the edge of said door fast, locking it in a substantially closed position.

4. The portable Add-Lock system of claim 3, further comprising in which said locking piece and/or ramped button(s) may, at a user's or the system's election, be depressed to remove said holding side of said locking piece and/or ramped button(s) from the swinging path of said door, unlocking said door.

5. The portable Add-Lock system of claim 4, further comprising in which said locking piece and/or ramped button(s) tend to be pushed in an extended position, interfering with the swinging path of said door, by a force biasing, such as a spring.

6. The portable Add-Lock system of claim 4, further comprising a locking piece capable of gripping a structural feature of a door jamb, doorway, molding, or other substantially fixed element in or about a room, creating locking structural force for said system to exert onto the surface of a door

7. The portable Add-Lock system of claim 6, further comprising in which said locking piece capable of gripping a structural feature is capable of insertion into a mortise or other latch-accepting hole in a door jamb.

8. The portable Add-Lock system of claim 6, further comprising a holding piece that allows a user to mount said system onto the door jamb, doorway, molding, or other substantially fixed element in or about a room, without otherwise causing damage or other changes to such an element, and in which said system may remain so mounted regardless of whether said door is opened, closed, locked and/or unlocked.

9. The portable Add-Lock system of claim 8, further comprising in which a part of said system holding at least a part of said locking piece and/or ramped button(s) may be pivoted, bent, rotated or otherwise moved out of the path of said swinging door to unlock it.

10. The portable Add-Lock system of claim 3, further comprising in which a line accessible through a space between a door and another object which may actuate at least some aspect of said system.

11. The portable Add-Lock system of claim 10, further comprising a fetch-facilitating piece at the end of said line.

12. The portable Add-Lock system of claim 11, further comprising in which the fetch-facilitating piece maintains an open loop in a position other than flat against the ground, easing the snaring of said loop.

13. The portable Add-Lock system of claim 3, further comprising a GUI presented and accessible from the side of the door opposite the locking mechanism, or some remainder of the system.

14. A portable Add-Lock system, comprising a door-locking device capable of mounting fast to a door, key-hole, or other associated, fixed structure, regardless of whether the Add-Lock system is presently locked or being locked, and requiring no damage or other permanent alterations to a door, doorframe or other parts of a room to install and/or uninstall.

15. The portable Add-Lock system of claim 14, further comprising where a key may be variably held, inserted and actuated in a lock by the system.

16. The portable Add-Lock system of claim 15, further comprising where a key may be variably retracted into a housing in the event that tampering is detected by said system.

17. The portable Add-Lock system of claim 14, further comprising where the key is covered by a retractable protective member with a convex tip, that may assist in guiding the key into a keyhole and/or protecting the key and/or other surfaces from errant, mutual scratching.

18. The portable Add-Lock system of claim 17, further comprising a GUI presented and accessible from the side of the door opposite the locking mechanism, or some remainder of the system.
